(19) United States
(12) Patent Application Publication
(10) Pub. No.: US 2022/0161586 A1
(43) Pub. Date: May 26, 2022

(54) CONTROLLED SURFACE WETTING RESULTING IN IMPROVED DIGITAL PRINT EDGE ACUITY AND RESOLUTION

(71) Applicant: AXALTA COATING SYSTEMS IP CO., LLC, Wilmington, DE (US)

(72) Inventor: Michael R. Koerner, Media, PA (US)

(73) Assignee: AXALTA COATING SYSTEMS IP CO., LLC, Wilmington, PA (US)

(21) Appl. No.: 17/310,997

(22) PCT Filed: Mar. 5, 2020
(86) PCT No.: PCT/US2020/021140

§ 371 Date: Sep. 3, 2021

Related U.S. Application Data
(60) Provisional application No. 62/814,507, filed on Mar. 6, 2019.

(51) Int. Cl. B41M 5/00

(52) U.S. Cl. CPC B41M 5/0047; B41M 5/0064; B41M 5/0011

(57) ABSTRACT

A method is described for applying a coating composition to a surface of a substrate in a pattern utilizing a non-contact deposition applicator to increase edge acuity and resolution of the coating composition in the pattern. The method includes the steps of providing the substrate having the surface that comprises a non-porous polymer, applying a surface treatment to the surface in a pattern to form a patterned surface that has increased surface energy as compared to the non-surface treated surface, providing the coating composition including a carrier and a binder, providing the non-contact deposition applicator including a nozzle, and applying the coating composition to the patterned surface through the nozzle to selectively wet the patterned surface and form a coating layer disposed in the pattern and having increased edge acuity and resolution, wherein the coating layer has a wet thickness of at least about 15 micrometers as applied.

### CROSS-REFERENCE TO RELATED APPLICATIONS

This application is a U.S. National-Stage entry under 35 U.S.C. § 371 based on International Application No. PCT/US2020/021140 filed Mar. 5, 2020, which was published under PCT Article 21(2) and which claims priority to U.S. Provisional Application No. 62/814,507 filed Mar. 6, 2019, which are all hereby incorporated in their entirety by reference.

### TECHNICAL FIELD

The present disclosure generally relates to a method of applying a coating composition to a surface of a substrate in a pattern utilizing a non-contact deposition applicator to increase edge acuity and resolution of the coating composition in the pattern. More specifically, this disclosure relates to applying a surface treatment to the surface in a pattern to form a patterned surface that has increased surface energy as compared to the non-surface treated surface and then applying the coating composition to the patterned surface to selectively wet the patterned surface and form a coating layer disposed in the pattern which has increased edge acuity and resolution.

### BACKGROUND

Ink jet printing is a non-impact printing process in which droplets of ink are deposited on a substrate in response to an electronic signal. These processes have the advantage of allowing digital printing of the substrate which can be tailored to individual requirements.

The droplets can be jetted onto the substrate by a variety of inkjet application methods including continuous or drop-on-demand printing. In drop-on-demand printing, the energy to eject a drop of ink can be provided by a thermal resistor, a piezoelectric crystal, acoustic or a solenoid valve. In a continuous mode, the fluid can stream directly to the substrate before or after it naturally breaks up into drops vis a vis Rayleigh instability. In continuous mode, more controlled drop break-up can be achieved by introducing a periodic piezoelectric stimulation prior to nozzle jetting. In other words, a PZT could be used to make more regular drops via a Stimulated Rayleigh method.

Conventional inkjet inks have typically been formulated to print on porous substrates where the ink is rapidly absorbed into the substrate thus facilitating drying and handling of the substrate shortly after printing. In addition, although the printed articles have sufficient durability for these applications, such as printed text and pictures, or patterned fabrics, the durability requirements of other applications are much more demanding. For example, automotive coatings have durability requirements that are far greater in terms of both physical durability, such as resistance to abrasion and chipping, and long-term durability to weathering and light resistance. Accordingly, inkjet inks are not used as automotive coatings.

In the automotive industry, a vehicle body is typically covered with a series of finishes including an electrocoat, a primer, a colored basecoat providing the color and a clear topcoat to provide addition protection and a glossy finish. Currently, most automobile bodies are painted in a single color with the basecoat being applied in a single spray operation. The coating is applied with pneumatic spray or rotary equipment producing a broad jet of paint droplets with a wide droplet size distribution. This has the advantage of producing a uniform high-quality coating in a relatively short time by an automated process.

However, there are disadvantages to using spraying technology. If the vehicle body is to be painted with multiple colors, for example a second color is used for a pattern such as a stripe, or a whole section of the vehicle body such as the roof is painted a different color, this requires masking the first coating and then passing the vehicle body through the paint spray process a second time to add the second color. After this second paint operation, the masking must be removed. This is both time-consuming and labor-intensive adding significant cost to the operation. In addition, such a process can cause jagged edges, blemishes and imperfections, paint bleeding, and coating peeling due to elastic release, especially around edges of the masking. An example is set forth in FIG. 5.

A second disadvantage of the current spraying technology is that the drops of paint are sprayed in a wide jet of droplets which has a wide range of droplet sizes. As a result, many of the droplets do not land on the vehicle, either because they are sprayed near the edges and so overspray the substrate, or because the smaller droplets have too low a momentum to reach the vehicle body. This excess overspray must be removed from the spray operation and disposed of safely leading to significant waste and also additional cost.

Moreover, automotive coatings are typically formulated such that, after being sprayed, they relax and increase in viscosity so as to resist sagging and slumping. For this reason, many are considered to have non-Newtonian characteristics. This is especially important when the automotive coatings are applied to vertical surfaces. However, these same properties effectively prevent such automotive coatings from being able to be applied using commercially available ink jet technology.

For example, ink jet inks known in the art are formulated to have a low and generally shear-rate independent, or Newtonian, viscosity, typically below 20 cps. This is because of the limited amount of energy available in each nozzle of a printhead to eject a drop and also to avoid thickening of the ink in the channels of the printhead potentially leading to clogging. Automotive coatings, on the other hand, typically have a significant non-Newtonian shear behavior with extremely high viscosity at low-shear to help avoid pigment settling and to ensure rapid and even set-up of the coating immediately after application, but relatively low viscosity at high shear rates to facilitate spraying and atomization of the spray into droplets.

For these reasons, if ink jet technology were used in the automotive industry, it would face unique challenges. For example, drop on demand (DOD) jetting, such as for inkjet inks, requires the inks to have low viscosities (e.g. <50 cp) at high shear rates experienced during droplet ejection (e.g. >1000 sec⁻¹). In principle, typical shear thinning automotive coatings would satisfy this criteria. However, in practice, high shear thinning automotive coatings cannot be jetted since, during a very fast startup time from low shear rate to high shear rate for droplet ejection, the automotive coatings tend to behave as viscoelastic solids of exceedingly high, if not almost infinite, viscosity such that droplets cannot be ejected. This is a result of their design to resist sagging and slumping. For example, during elapsed time between mixing and spraying, the automotive coatings would relax to such a degree that the viscosity would greatly increase. This would prevent the coating from being able to be ejected or jetted. In addition, even if by some mechanism droplet ejection could be achieved, there would likely be multiple stagnation points in the printhead that would prevent the automotive coatings from having a sufficiently low viscosity to effectively refill droplet ejection chambers.

Moreover, and as shown in FIG. 1, there are drop limitations that are realized relative to nozzle spacing direction wherein high frequency jetting allows for close drop spacing in a traverse direction but nozzle spacing limits close drop location. This can result in poor print quality which is especially noticeable with automotive coatings.

Furthermore, and as is shown in FIG. 2, two additional approaches to placing more drops in a nozzle spacing direction include the use of multiple arrays that are ganged together and offset and the use of an array at a pitched angle. However, limitations on drop size, spacing, and wetting are still realized. As a result, it is known to control drop size at the nozzle, wherein larger drops are a collection of smaller sub-drops, as is shown in FIG. 3. However, low composition viscosity is required. Most automotive coatings do not have such viscosities and therefore cannot be used in such a method.

In addition, many inkjet printhead manufacturers use variable dropsize to improve edge acuity. Larger drops are a collection of smaller sub-drops wherein the smaller drops are placed between larger drops to improved perceived resolution. However, inks must have low viscosity to function in this manner. Automotive coating compositions typically do not have low enough viscosities to be able to be used with such technology. An example is set forth in FIG. 4.

Still further, problems can arise due to the thixotropy of automotive coating compositions, also known as rebuilding time. It is known in the art that automotive coatings take time to rebuild their rheological properties after being mixed and/or sheared in various application devices. This rebuilding time can introduce irregularities into coating processes such that the coating compositions may not be ejected from the application devices with the predicted speed, accuracy, timing, or viscosity. This is especially important with ink-jet technologies which heavily rely on precise timing and placement of very small droplets. If the speed, accuracy, timing, or viscosity of the coating compositions is not correct, then irregularities can develop in the coating on the surface of the substrate which may render the ultimate product unusable.

Furthermore, when applying paint patterns on substrates that have non-porous polymer surfaces, such as automobile components, using non-contact digital techniques, there is a fundamental resolution limit based on droplet size and placement accuracy of drops of the coating composition. Film build requirements and high paint viscosity limit drop sizes that could otherwise achieve higher resolution or improve edge acuity. When larger paint drops are applied to the substrate, there will be some flow, wetting, and coalescence that takes place. This could further distort image or pattern acuity.

To be more specific, the size of a droplet on a substrate is a function of the drop volume jetted by an applicator and is influenced by the characteristics of the composition and the substrate. Smaller drop sizes produce smaller droplets which results in a lower color density, thus improving image highlight areas. However, smaller drop sizes are not always superior. An array of printed dots which do not fully overlap and have white space between them will not be suitable for solid areas or bold text. A larger dot size can ensure that full solid coverage and stronger or higher opacity colors are achieved.

The basis of all print imaging is the accumulation of dots at specific points on a substrate which create lines, solid areas or halftone patterns. If there are differences between the intended position of the dots and their actual position, image quality artefacts will result. To ensure precise imaging, each printed dot must be placed in the exact predetermined position on the substrate. An error from this position directly affects the quality of features such as lines and text exhibiting ‘ragged edges’, and can also affect color registration, resulting in white lines in images or solid areas.

Drop placement accuracy also affects the quality of the final product. For example, air bubbles or particles which are present in the applicator can cause deviated nozzles or misdirects which can only be removed by regular maintenance or replacement of the applicator.

Print quality can also be affected by the consistency of drop volume, and therefore drop size and composition thickness across print width. Bands of different color density visible in the image in the print direction are highly undesirable, but can result from inconsistent drop volumes across an applicator width and, where there is variation in applicators, across the entire print width. Consistency of drop size is influenced not only by the physical capability of an applicator to jet drops of equal volume, but also its ability to regulate and manage the heat that builds up through the process of actuation. A variation in temperature can affect compositional viscosity and the drop size which will be ejected. A higher temperature in one area of an applicator will result in a higher drop volume and increased density of composition which can be extremely difficult to manage.

As described above, since automotive coatings differ significantly in physical properties from typical ink-jet inks, all of the aforementioned issues can be magnified and made more difficult to control and manage.

Accordingly, there remains an opportunity to develop an improved method of applying coating compositions to various substrates. Furthermore, other desirable features and characteristics will become apparent from the subsequent detailed description and the appended claims, taken in conjunction with this background.

### BRIEF SUMMARY AND ADVANTAGES

This disclosure provides a method of applying a coating composition to a surface of a substrate in a pattern utilizing a non-contact deposition applicator to increase edge acuity and resolution of the coating composition in the pattern. The method includes the steps of providing the substrate having the surface that includes a non-porous polymer, applying a surface treatment to the surface in a pattern to form a patterned surface that has increased surface energy as compared to the non-surface treated surface, providing the coating composition including a carrier and a binder, providing the non-contact deposition applicator including a nozzle, and applying the coating composition to the patterned surface through the nozzle to selectively wet the patterned surface and form a coating layer disposed in the pattern and having increased edge acuity and resolution, wherein the coating layer has a wet thickness of at least about 15 micrometers as applied.

This disclosure also provides a method of pretreating a substrate onto which a patterned coating composition is applied utilizing a non-contact dropwise deposition applicator such that increased edge acuity and resolution is achieved. The method includes the steps of providing the substrate having a surface that includes a non-porous polymer, pretreating the surface to form a pattern that has increased surface energy as compared to the non-surface treated surface, providing the coating composition including a carrier and a binder, providing the non-contact dropwise deposition applicator including a nozzle, and applying the coating composition to the patterned surface through the nozzle to selectively wet the patterned surface and form the patterned coating having increased edge acuity and resolution, wherein the coating layer has a wet thickness of at least about 15 micrometers as applied.

This disclosure further provides a method of applying an automotive coating composition to a surface of an automobile component in a pattern utilizing an inkjet print head to increase edge acuity and resolution of the automotive coating composition in the pattern. The method includes the steps of providing the automobile component having the surface that includes a non-porous polymer chosen from a first water-borne or solvent-borne basecoat composition, applying a mask to the surface of the substrate, wherein the mask is disposed in the pattern, applying a surface treatment to the surface over the mask to form a positive and/or negative patterned surface that has increased surface energy as compared to the non-treated surface wherein the surface treatment is chosen from flame treatment, corona treatment, plasma treatment, and combinations thereof, removing the mask subsequent to the step of applying the surface treatment; providing the automotive coating composition including a carrier and a binder wherein the automotive coating composition is a second water-borne or solvent-borne basecoat composition, providing the inkjet print head including a nozzle, and applying the automotive coating composition to the patterned surface through the nozzle to selectively wet the patterned surface to form a coating layer disposed in the pattern and having increased edge acuity and resolution, wherein the coating layer has a wet thickness of at least about 15 micrometers as applied and wherein the inkjet print head applies the composition via droplets having an average diameter of greater than about 50 micrometers.

Relative to potential advantages associated with the instant method, it is theorized that when automotive paints are applied using traditional for-ink applicators, the large paint drops will not be able to achieve sufficient resolution to give edge acuity demanded by OEM automotive customers. However, if the substrate is pretreated to increase selective wetting of certain areas of the surface as compared to other areas, the paint will flow into the desired places thereby increasing edge acuity and resolution to sufficient levels, e.g. to the level of visual acuity at a viewing distance of from a few inches to many feet. Moreover, in some embodiments, the use of masking techniques can direct the surface treatment at a high resolution thereby allowing larger paint drops to wet the target surface and not wet the untreated areas, thereby increasing edge acuity and resolution. These techniques can enable OEMs to utilize available low resolution printheads with various coating compositions having higher viscosities and still achieve high resolution images or patterns with excellent edge acuity.

### BRIEF DESCRIPTION OF THE DRAWINGS

The present disclosure will hereinafter be described in conjunction with the following drawing figures, wherein:

FIG. 1 is a general schematic showing approximate drop limitations relative to nozzle spacing direction wherein high frequency jetting allows for close drop spacing in a traverse direction but nozzle spacing limits close drop location;

FIG. 2 is a general schematic showing two additional approaches to placing more drops in a nozzle spacing direction including the use of multiple arrays that are ganged together and offset and the use of an array at a pitched angle;

FIG. 3 is a general schematic showing an approach used in the ink-jet industry wherein drop size is controlled at the nozzle, wherein larger drops are a collection of smaller sub-drops, and wherein low composition viscosity is required;

FIG. 4 is an image of how smaller drops can be placed between larger drops to improve perceived resolution wherein low composition viscosity is required; and

FIG. 5 is an image of various types of blemishes that can result from the use of prior art methods of applying coating compositions to automobile components.

### DETAILED DESCRIPTION

The following detailed description is merely exemplary in nature and is not intended to limit the instant method. Furthermore, there is no intention to be bound by any theory presented in the preceding background or the following detailed description.

Embodiments of the present disclosure are generally directed methods of applying coating compositions and the coating compositions themselves. For the sake of brevity, conventional techniques related to such methods and compositions may not be described in detail herein. Moreover, the various tasks and process steps described herein may be incorporated into a more comprehensive procedure or process having additional steps or functionality not described in detail herein. In particular, various steps in the manufacture of coating compositions are well-known and so, in the interest of brevity, many conventional steps will only be mentioned briefly herein or will be omitted entirely without providing the well-known process details.

Use of a printhead, such as an inkjet style printhead, allows coating compositions to be applied to a variety of substrates, such as automobiles, using jetting technology. This can allow for multiple colors to be used, can minimize overspray, e.g. by generating drops of a uniform size that can be directed to a specific point on the substrate, and minimize, or even completely eliminate, oversprayed droplets. In addition, digital printing can be used to print patterns or two tones on the substrate, either as a second color digitally printed on the top of a previously sprayed basecoat of a different color, or directly onto a primed or clearcoated substrate.

Method of this Disclosure:

This disclosure provides a method of applying a coating composition, hereinafter alternatively referred to as “the composition”, to a substrate utilizing an applicator, such as an inkjet print head. More specifically, this disclosure provides a method of applying the composition to a surface of a substrate in a pattern utilizing a non-contact deposition applicator to increase edge acuity and resolution of the coating composition in the pattern. The method includes the steps of providing the substrate having the surface that includes a non-porous polymer, applying a surface treatment to the surface in a pattern to form a patterned surface that has increased surface energy as compared to the non-surface treated surface, providing the coating composition including a carrier and a binder, providing the non-contact deposition applicator including a nozzle, and applying the coating composition to the patterned surface through the nozzle to selectively wet the patterned surface and form a coating layer disposed in the pattern and having increased edge acuity and resolution, wherein the coating layer has a wet (applied) thickness of at least about 15 micrometers. Each of the composition, the applicator, etc. is described in detail below.

Providing the Substrate Having the Surface that Includes a Non-Porous Polymer:

As described above, the method includes the steps of providing the substrate having the surface that includes a non-porous polymer. The substrate may be any known in the art and may include plastic, glass, metal, polymers, wood, etc. In various embodiments, the substrate may include a metal-containing material, a plastic-containing material, or a combination thereof. The substrate may be any component of an automobile, truck, train, airplane, ship, etc.

In various embodiments, the substrate itself is substantially non-porous. The term “substantially” as utilized herein means that at least about 95%, at least about 96%, at least about 97%, at least about 98%, at least about 99% of a surface of the coating layer is free of pores. It is also contemplated that, in various non-limiting embodiments, all values and ranges of values, both whole and fractional, including and between those set forth above, are hereby expressly contemplated for use herein.

Similarly, the surface of the substrate typically includes the non-porous polymer, which also means that at least about 95%, at least about 96%, at least about 97%, at least about 98%, at least about 99% of the polymer itself is free of pores. The polymer may be any known in the art. In various embodiments, the polymer is, for example, a 1K high solids acrylosilane with melamine, a 2K medium solids acrylic with isocyanate, a 2K acrylic with isocyanate modified with silica particles, a TPO, or a talc filled PP copolymer, with high melt flow, good paintability, excellent impact/stiffness balance and processability. It is also contemplated that, in various non-limiting embodiments, all values and ranges of values, both whole and fractional, including and between those set forth above, are hereby expressly contemplated for use herein.

In one embodiment, the non-porous polymer is a baked clear coat and the coating composition is a wet solvent-borne topcoat composition. In another embodiment, the non-porous polymer is a dry water-borne basecoat composition and the coating composition is a wet second water-borne basecoat composition. In another embodiment, the non-porous polymer is a wet water-borne basecoat composition and the coating composition is a wet second water-borne basecoat composition. In a further embodiment, the non-porous polymer is a wet solvent-borne basecoat composition and the coating composition is a wet second solvent-borne basecoat composition. In yet another embodiment, the non-porous polymer is a wet solvent-borne basecoat composition and the coating composition is a wet second solvent-borne basecoat composition. The water and/or solvent borne basecoat compositions may be any known in the art and may be any described below.

In various embodiments, the substrate is a vehicle, automobile, or automobile vehicle. “Vehicle” or “automobile” or “automobile vehicle” includes an automobile, such as, car, van, minivan, bus, SUV (sports utility vehicle); truck; semi-truck; tractor; motorcycle; trailer; ATV (all-terrain vehicle); pickup truck; heavy duty mover, such as, bulldozer, mobile crane and earth mover; airplanes; boats; ships; and other modes of transport. The composition may also be utilized to coat substrates in industrial applications such as buildings; fences; ceramic tiles; stationary structures; bridges; pipes; cellulosic materials (e.g., woods, paper, fiber, etc.). The composition may also be utilized to coat substrates in consumer products applications such as helmets; baseball bats; bicycles; and toys. It is to be appreciated that the term “substrate” as utilized herein can also refer to a coating layer disposed on an article that is also considered a substrate.

Various substrates may include two or more discrete portions of different materials. For example, vehicles can include metal-containing body portions and plastic-containing trim portions. Due to the bake temperature limitations of plastics (about 80° C.) relative to metals (about 140° C.), the metal-containing body portions and the plastic-containing trim portions may be conventionally coated in separate facilities thereby increasing the likelihood for mismatched coated parts. A composition suitable for plastic substrates may be applied to the plastic substrates by the non-contact deposition applicator after application and bake of the composition suitable for metal substrates. The composition suitable for plastic substrates may be applied using a first non-contact deposition applicator and the composition suitable for metal substrates may be applied using a second non-contact deposition applicator. The first non-contact deposition applicator and the second non-contact deposition applicator may form a non-contact deposition applicator assembly.

In various embodiments, the substrate is disposed within an environment including an overspray capture device. An air flow may move through the environment and to the overspray capture device. In various embodiments, no more than about 20 wt. % of the composition expelled from the non-contact deposition applicator may contact the overspray capture device, based on a total weight of the composition. In other embodiments, no more than about 15 wt. %, alternatively no more than about 10 wt. %, alternatively no more than about 5 wt. %, alternatively no more than about 3 wt. %, alternatively no more than about 2 wt. %, or alternatively no more than about 0.1 wt. %, of the composition expelled from the non-contact deposition applicator may contact the overspray capture device, based on a total weight of the composition. The overspray capture device may include a filter, a scrubber, or combinations thereof. It is also contemplated that, in various non-limiting embodiments, all values and ranges of values, both whole and fractional, including and between those set forth above, are hereby expressly contemplated for use herein.

In various embodiments, the substrate is susceptible to damage from corrosion. Although modern automotive substrates include an electrocoat layer to prevent corrosion on interior and exterior surfaces of vehicles, an additional corrosion protection composition may be applied to the substrate by the non-contact deposition applicator in a pre-defined location without the need for masking the substrate and wasting a portion of the corrosion protection composition through low-transfer efficiency application methods, such as conventional spray atomization.

### Applying a Surface Treatment to the Surface in a Pattern:

The method also includes the step of applying a surface treatment to the surface in a pattern to form a patterned surface that has increased surface energy as compared to the non-surface treated surface.

Solid surfaces have a surface energy specific for various materials. For a liquid drop to spread on a given surface, the liquid surface tension must be lower than the critical surface tension of the solid. Metal and glass exhibit a high surface energy, whereas plastics have a low surface energy. Surface treatment increases the surface energy and therefore the wettability of the surface. Surface treatment may also eliminate a weak boundary layer, thus improving adhesion. In many cases, the objective is to treat the surface to a predetermined critical surface tension expressed in dynes per centimeter. ASTM specification D-278-84 describes a method of evaluating the level of surface treatment. An increase in surface energy is usually related to an improved adhesion of compositions. However, sometimes a substrate may be wettable and still not provide the desired adhesion level.

After the surface treatment, the treated surface will have a higher or increased surface energy as compared to the rest of the surface that was not surface treated. For example, this increase in surface energy may be greater than about 1, 2, 3, 4, 5, 6, 7, 8, 9, 10, 11, 12, 13, 14, or 15, mN/m, or even greater. In other embodiments, the increase in surface energy is from about 1 to about 15, about 5 to about 10, about 10 to about 15, about 5 to about 5, about 4 to about 11, about 4 to about 6, or about 6 to about 11, mN/m. It is also contemplated that, in various non-limiting embodiments, all values and ranges of values, both whole and fractional, including and between those set forth above, are hereby expressly contemplated for use herein.

The surface treatment of this disclosure is not particularly limited and may be any known in the art. For example, the surface treatment may be chosen from flame treatment, corona treatment, plasma treatment, and combinations thereof. In one embodiment, the surface treatment is flame treatment. In another embodiment, the surface treatment is corona treatment. In yet another embodiment, the surface treatment is plasma treatment. In still another embodiment, the surface treatment is a combination of two or more of these types of treatment. It is also contemplated that other surface treatments can be used such as physically or chemically roughening the surface, abrading the surface, reactive gas treatment, etc.

In flame treating, a high temperature of the combustion gases causes oxygen molecules to become disassociated, forming free, highly chemically active oxygen atoms. In flame treating, these high speed, energetic, very reactive oxygen ions or free oxygen atoms bombard the surface of the substrate and react with the molecules. This process oxidizes the surface and requires an oxidizing flame, which is a flame with an excess of oxygen. Any type of burner can be used, e.g. an atmospheric burner, a power burner, a burner designed for film posttreatment application, a ribbon burner, etc.

Corona treatment is a surface modification method using a low temperature corona discharge to increase the surface energy of the surface. Most commonly, the surface of the substrate is passed through an array of high-voltage electrodes, using a plasma created to functionalize the surface. The limited penetration depth of such treatment provides vastly improved adhesion while preserving bulk mechanical properties. Several factors influence the efficiency of the treatment such as air-to-gas ratio, thermal output, surface distance, and oxidation zone dwell time.

Plasmas can be produced and controlled by ionizing a gas with an electromagnetic field of sufficient power. One useful form of gas plasma is made by introducing gas into a reaction chamber, maintaining pressure between about 0.1 and about 10 torr, and then applying radio frequency (rf) energy. Once ionized, excited gas species react with the surface of the substrate placed in the glow discharge. In other embodiment, high temperature combustion processes can cause oxygen atoms to lose electrons to become positively charged oxygen ions. Such an electrically neutral gas made of equal amounts of positively and negatively charged particles is known as a plasma. Plasma may be hot or cold.

The physical and chemical properties of plasmas depend on many variables; chemistry, flow rate, distribution, temperature, and pressure of the gases. Additionally, rf excitation frequency, power level, reactor geometry, and electrode design are also important. Dissociated gas molecules quickly recombine to their natural state when the plasma's power source is shut off.

Plasmas occur over a wide range of temperatures and pressures, however, all plasmas have approximately equal concentrations of positive and negative charge carriers, so that their net space charge approaches zero. In general, all plasmas fall into one of three classifications. Elements of high-pressure plasmas, also called hot plasmas, are in thermal equilibrium (often at energies>about 10,000° C.). Examples include stellar interiors and thermonuclear plasmas. Mixed plasmas have high temperature electrons in mid-temperature gas (˜100 to about 1000° C.) and are formed at atmospheric pressures. Arc welders and corona surface treatment systems use mixed plasmas. Cold plasmas are not in thermal equilibrium. While the bulk gas is at room temperature, the temperature (kinetic energy) of the free electrons in the ionized gas can be about 10 to about 100 times higher (as hot as about 10,000° C.), thus producing an unusual, and extremely chemically reactive environment at ambient temperatures. Any of these may be utilized herein.

There are two types of cold plasma, as determined by electrode configuration. Primary plasmas are generated directly by rf energy between the electrodes of a reaction chamber. Secondary plasmas exist downstream of the energy field, carried by gas flow and diffusion. Secondary plasmas are less desirable for surface modification because the farther downstream from the rf field the parts to be treated are, the less reactive the plasma becomes. One part may shield another, creating nonuniformity, and less surface area can be treated before all active species are locally depleted, reducing effectiveness with larger loads. Any of these may be utilized herein.

Three properties of the cold gas plasma—chemical dissociation, kinetic energy from ionic acceleration, and photochemistry—make this unique environment effective for surface treatment. Exposing gases to sufficient electromagnetic power dissociates them, creating a chemically reactive gas that quickly modifies exposed surfaces. At the atomic level, plasma contains ions, electrons, and various neutral species at many different energy levels. One of the excited species formed is the free radical, which can directly react with the surface of the substrate, leading to dramatic modifications to their chemical structure and properties. Modification sites also occur when ions and electrons bombarding the surface have gained enough kinetic energy from the altering electromagnetic field to knock atoms or groups of atoms from surfaces. Furthermore, gas-phase collisions transfer energy—forming more free radicals, atoms, and ions. Any of these may be utilized herein.

Combining dissociated species gives off photons as they are returning to their ground state. The spectrum of this glow discharge includes high energy UV photons, which will be absorbed on the top surface layers of the substrate, thus creating even more active sites. The color of the glow discharge depends on the plasma chemistry, and its intensity depends on the processing variables.

The plasma process modifies only several molecular layers, thus appearance and bulk properties are usually unaffected. In addition, plasma changes the molecular weight of the surface layer by scissioning (reduction in molecular length), branching, and cross-linking organic materials. The chemistry of the plasma determines its effects on the surface of the substrate.

Activating plasmas have three competing molecular reactions that alter the surface of the substrate simultaneously, especially if the surface is a polymer. The extent of each depends on the chemistry and the process variables. They are as follows: Ablation (microetching), or removal by evaporating surface material either for cleaning or for creating surface topography; Cross-linking, or creating covalent bonds or links between parallel long molecular chains; and Substitution, the act of replacing atoms in the molecule with atoms from the plasma.

Ablation is an evaporation reaction in which the plasma breaks carbon-to-carbon bonds the polymer of the surface of the substrate. As long molecules become shorter, their volatile monomers or oligomers boil off (ablate), and they are swept away with the exhaust. Ablation is important for surface cleaning, and where desired, for surface etching. Cleaning removes from surfaces such external organic contaminants as hydraulic oils and mold releases. Equally important is the removal of internal contaminants such as processing aids and internal lubricants that have bloomed to the surface. Often, an oxygen-containing plasma is selected to facilitate rapid breakdown of the suspected contaminant into a volatile by-product. Cleaning by plasma is more effective than cleaning by vapor degreasing or by other methods. Plasma produces a “superclean” surface; but if gross contamination exists, parts may be precleaned by ultrasonic cleaning, or solvent-vapor degreasing so that the plasma process time is kept to a minimum and thus remains cost effective.

Once cleaned, the plasma begins ablating the top molecular layer of the polymer of the surface of the substrate. Amorphous, filled, and crystalline portions will be removed at different rates, giving a technique effective for increasing surface topography with a view to increasing mechanical adhesion or for removing weak boundary layers formed during molding.

Cross-linking, on the other hand, is done with an oxygen-free noble gas (argon or helium). After the plasma has generated surface free radicals, these react with radicals on adjoining molecules or molecular fragments to form cross-links. This process increases the strength, the temperature resistance, and the solvent resistance of the surface of the substrate.

Unlike ablation or cross-linking, substitution replaces one atom or group from the surface of the polymer of the substrate with active species from the plasma. In this case, free radical sites on the surface of the polymer of the substrate are free to react with species in the plasma, including, but not exclusively, free radicals, thus altering surface chemistries by the addition of covalently bonded functional groups. The selection of the process gas determines which groups will be formed on the surface of the polymer of the substrate. Gases or mixtures of gases used for plasma treatment of polymers include nitrogen, argon, oxygen, nitrous oxide, helium, tetrafluoromethane, water, and ammonia. Each gas produces a unique plasma chemistry. Surface energy can be quickly increased by plasma-induced oxidation, nitration, hydrolyzation, or amination.

Very aggressive plasmas can be created from relatively benign gases. For example, an oxygen and tetrafluoromethane (Freon 14) plasma contains free radicals of fluorine. Oxidation by fluorine free radicals is known to be as effective as oxidation by the strongest mineral acid etchant solutions, with one important difference: hazardous and corrosive materials are not used. As soon as the plasma is shut off, the excited species recombine to their original stable and nonreactive form. In most cases, treatment of the exhaust effluent is not required.

Gases that contain oxygen are generally more effective at increasing surface energy. For example, plasma oxidation of polypropylene increases the initial surface energy of about 29 dynes/cm to well over about 73 dynes/Cm in just a few seconds. At about 73 dynes/Cm, the polypropylene surface is completely water wettable. Increased surface energy results in a plasma that yields polar groups, such as carboxyl, hydroxyl, hydro-peroxyl, and amino. A higher energy (hydrophilic) surface translates to better wetting and greater chemical reactivity of the modified surface to coating compositions providing for improved adhesion and permanency.

The enhanced surface reactivity is characterized in the laboratory by studying water wettability. Wettability describes the ability to spread over and penetrate a surface. It is measured by the contact angle between the liquid and the surface. The relationship between contact angle and surface energy is inverse the contact angle decreases with increasing surface energy. Wettability can easily be induced on normally nonwettable materials such as polyolefins, engineering thermoplastics, fluoropolymers, thermosets, rubbers, and fluoroelastomers.

Noble gases (argon, helium, etc.) generate surface free radicals that react either with other radicals on the surface, yielding molecular weight changes, or with the air, when the part is removed from the chamber, thus increasing the surface energy.

Process gases such as fluorocarbons will generally provide a lower energy, or hydrophobic, surface by substitution of abstracted hydrogen with either fluorine or trifluoromethyl radicals to form a fluorocarbon surface.

### Pattern:

The method also includes applying the composition to the surface of the substrate in a pattern utilizing the non-contact deposition applicator to increase edge acuity and resolution of the composition in the pattern. Referring to the pattern, the pattern may be any known in the art. For example, the pattern may be any shape, e.g. circular, oval, square, rectangular, etc. The pattern may be a line or a dashed line. The pattern may be a racing stripe. The pattern may be a full roof or hood or body panel of an automobile, a horizontal stripe, a vertical rocker panel, a triggered or partial stripe, text, and/or a raster image. The pattern may be sized and shaped to match any portion of an automobile. The pattern may be defined as a repeated decorative design or as a spot, stripe, geometric or non-geometric design. The pattern may be a solid color or a mixture of colors. The pattern may be textured or be free of texture. The pattern may be black, white, grey, solid, or metallic. The pattern may be clear or opaque. The pattern may be a symbol, trade name, company name, product name, sign, advertisement, numbers, numerals, a drawing, or a photograph. The pattern may be further defined as a logo, design, signage, stripe, camouflage, and the like. The pattern may be symmetric or non-symmetric, in whole or in part. The pattern may be formed using a mask, as described in greater detail below, without a mask, or both with and without a mask wherein one portion of the pattern is formed with the mask and another portion of the pattern is formed without the mask.

### Applying a Mask to the Surface of the Substrate:

The method may also include the step of applying a mask to the surface of the substrate prior to the step of applying the surface treatment, wherein the mask is disposed in the pattern, wherein the step of applying the surface treatment is further defined as applying the surface treatment over the mask such that the surface treatment forms a positive and/or negative patterned surface, and wherein the method further includes the step of removing the mask subsequent to the step of applying the surface treatment. Alternatively, the step of applying the surface treatment in the pattern can be completed without a mask. The mask is not particularly limited and may be any known in the art. For example, the mask may be alternatively described as masking. The mask can then be removed subsequent to the step of applying the surface treatment.

### Providing the Coating Composition:

The method further includes the step of providing the coating composition including a carrier and a binder. The composition of this disclosure is typically shear-thinning which means that as increasing amounts of shear is applied, the viscosity of the composition decreases and the compositions thins. Typically, this occurs as a result of the composition exhibiting non-Newtonian characteristics. In other words, as increasing amounts of shear are applied, the viscosity decreases. However, as shear is decreased or removed (e.g. if mixing or circulation ceases), the viscosity tends to increase. If the composition is at rest and a shearing force, such as from a printhead, jetting nozzle, or the like is applied, the composition will typically exhibit a very high viscosity and can act almost as a solid, thereby impeding or rendering impossible any act of spraying or jetting through a printhead, jetting nozzle, or the like.

More specifically, the composition is typically not an ink or a dye but could be an ink or dye. Typically, the composition is typically described as an automotive coating composition or industrial or automotive paint. The coating typically cures to foam a coating layer, coating, or layer, as is described in greater detail below.

Referring now to the composition itself, the composition can have a solids content of from about 5 to about 90 weight % based on a total weight of the composition as determined using ASTM D2369-10. In other embodiments, the solids content is from about 5 to about 80, about 10 to about 75, about 15 to about 70, about 20 to about 65, about 25 to about 60, about 30 to about 55, about 35 to about 50, or about 40 to about 45, wt. %, based on a total weight of the composition as determined using ASTM D2369-10. In various embodiments, a higher solids content may be desired due to the composition not undergoing atomization utilizing conventional spray equipment. Moreover, it is also contemplated that, in some embodiments, the solids content may be up to about 100 wt % based on a total weight of the composition as determined using ASTM D2369-10. It is also contemplated that, in various non-limiting embodiments, all values and ranges of values, both whole and fractional, including and between those set forth above, are hereby expressly contemplated for use herein.

### Carrier

The composition includes a carrier. In one embodiment, the carrier is chosen from water, a non-aqueous solvent, and combinations thereof. Accordingly, the composition may be an aqueous (water borne) composition or a non-aqueous (solvent borne) composition. The carrier may be utilized/present in any amount as is chosen by one of skill in the art.

In various embodiments, the carrier is a solvent and the composition is a solvent borne composition. In such embodiments, an organic solvent content is greater than about 50 wt. %, alternatively greater than about 60 wt. %, alternatively greater than about 70 wt. %, alternatively greater than about 80 wt. %, or alternatively greater than about 90 wt. %, based on a total weight of liquid carrier in the composition. Non-limiting examples of suitable organic solvents can include aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate, and a combination thereof. In various embodiments, the evaporation rate of the solvent may have an impact on the suitability of the composition for jetting. Certain co-solvents may be incorporated into the composition having increased or decreased evaporation rates thereby increasing or decreasing the evaporation rate of the composition. It is also contemplated that, in various non-limiting embodiments, all values and ranges of values, both whole and fractional, including and between those set forth above, are hereby expressly contemplated for use herein.

In other embodiments, the carrier is water and the composition is a waterborne composition. In such embodiments, the water content is greater than about 50 wt. %, alternatively greater than about 60 wt. %, alternatively greater than about 70 wt. %, alternatively greater than about 80 wt. %, or alternatively greater than about 90 wt. %, based on a total weight of liquid carrier in the composition. The composition may have a pH of from about 1 to about 14, alternatively from about 5 to about 12, or alternatively from about 8 to about 10. It is also contemplated that, in various non-limiting embodiments, all values and ranges of values, both whole and fractional, including and between those set forth above, are hereby expressly contemplated for use herein.

### Binder

The composition also includes a binder. For example, the binder may be present in an amount of from about 15 to about 70 weight % based on a total weight of the composition. In various embodiments, the binder is present in an amount of from about 20 to about 65, about 25 to about 60, about 30 to about 55, about 40 to about 50, or about 45 to about 50, weight percent based on a total weight of the composition. It is also contemplated that, in various non-limiting embodiments, all values and ranges of values, both whole and fractional, including and between those set forth above, are hereby expressly contemplated for use herein.

The term “binder” typically refers to film forming constituents of the composition. Typically, a binder can include polymers, oligomers, or a combination thereof that are used for forming a coating having desired properties, such as hardness, protection, adhesion, and others. Additional components, such as carriers, pigments, catalysts, rheology modifiers, antioxidants, UV stabilizers and absorbers, leveling agents, antifoaming agents, anti-cratering agents, or other conventional additives may, or may not, be included in the term “binder” depending on whether these additional components are film forming constituents of the composition. One or more of these additional components can be included in the composition. In various embodiments, the binder includes polymers.

Aqueous polyurethane binders and their production are well known to the skilled person. Typical and useful non-limiting examples of aqueous polyurethane binders include aqueous polyurethane binder dispersions which can typically be made by first forming an NCO-functional hydrophilic polyurethane prepolymer by addition reaction of polyol type compounds and polyisocyanates, conversion of the so-formed polyurethane prepolymer into the aqueous phase and then reacting the aqueously dispersed NCO-functional polyurethane prepolymer with an NCO-reactive chain extender like, for example, a polyamine, a hydrazine derivative or water. Such aqueous polyurethane binder dispersions used as binders in waterborne base coat compositions are conventional in the production of base coat/clear coat two-layer coatings of car bodies and body parts. Non-limiting examples of aqueous polyurethane binder dispersions which can be used herein are described in U.S. Pat. Nos. 4,851,460, 5,342,882 and US 2010/0048811 A1, each of which are expressly incorporated herein by reference in various non-limiting embodiments.

One non-limiting example of a polyester-polyurethane polymer is a polyurethane dispersion resin formed from a linear polyester diol resin (reaction product of monomers 1,6-hexanediol, adipic acid, and isophthalic acid) and isophorone diisocyanate. This polyester-polyurethane polymer has a weight average molecular weight of about 30,000, a solids content of about 35 wt. %, and a particle size of about 250 nanometers.

Another non-limiting example of a polyester-polyurethane polymer is a polyurethane dispersion resin formed from a linear polycarbonate-polyester and isophorone diisocyanate. This polyester-polyurethane polymer has a weight average molecular weight of about 75,000, a solids content of about 35 wt. %, and a particle size of about 180 nanometers.

In various embodiments, the composition including the polyester-polyurethane polymer may exhibit an increase in the elasticity as compared to a composition free of the polyester-polyurethane polymer. An increase in elasticity of the composition may improve suitability of the composition for application to the substrate utilizing the non-contact deposition applicator. In various embodiments, the composition may include the polyester-polyurethane polymer in an amount of from about 0.1 to about 50, alternatively from about 1 to about 20, or alternatively from about 1 to about 10, wt. %, based on a total weight of the composition. In exemplary embodiments, the composition includes a polyester-polyurethane polymer having the tradename Bayhydrol® U 241 which is commercially available from Covestro AG of Leverkusen, Germany. It is also contemplated that, in various non-limiting embodiments, all values and ranges of values, both whole and fractional, including and between those set forth above, are hereby expressly contemplated for use herein.

The binder may alternatively include latex polymers. Aqueous (meth)acryl copolymer latex binders and their production are well known to the skilled person. Aqueous (meth)acryl copolymer latex binders can typically be made by free-radical emulsion copolymerization of olefinically unsaturated free-radically copolymerizable comonomers. Examples are described in WO2006/118974 A1, WO2008/124136 A1, WO2008/124137 A1 and WO2008/124141 A1, each of which are expressly incorporated herein by reference in various non-limiting embodiments. These references disclose aqueous (meth)acryl copolymer latex binders and their use as binders in waterborne base coat compositions as are conventional in the production of base coat/clear coat two-layer coatings of car bodies and body parts. The aqueous (meth)acryl copolymer latex binders disclosed in WO2006/118974 A1, WO2008/124136 A1, WO2008/124137 A1 and WO2008/124141 A1, which are expressly incorporated herein by reference, are non-limiting examples of aqueous (meth)acryl copolymer latex binders which can be used in the composition.

Melamine resins may also be used and may be partially or fully etherified with one or more alcohols like methanol or butanol. A non-limiting example is hexamethoxymethyl melamine. Non-limiting examples of suitable melamine resins include monomeric melamine, polymeric melamine-formaldehyde resin, or a combination thereof. The monomeric melamines include low molecular weight melamines which contain, on an average, three or more methylol groups etherized with a C₁ to C₅ monohydric alcohol such as methanol, n-butanol, or isobutanol per triazine nucleus, and have an average degree of condensation up to about 2 and, in various embodiments, in the range of from about 1.1 to about 1.8, and have a proportion of mononuclear species not less than about 50 percent by weight. By contrast the polymeric melamines have an average degree of condensation of more than about 1.9. Some such suitable monomeric melamines include alkylated melamines, such as methylated, butylated, isobutylated melamines and mixtures thereof. Many of these suitable monomeric melamines are supplied commercially. For example, Cytec Industries Inc., West Patterson, N.J. supplies Cymel® 301 (degree of polymerization of 1.5, 95% methyl and 5% methylol), Cymel® 350 (degree of polymerization of 1.6, 84% methyl and 16% methylol), 303, 325, 327, 370 and XW3106, which are all monomeric melamines. Suitable polymeric melamines include high amino (partially alkylated, —N, —H) melamine known as Resimene® BMP5503 (molecular weight 690, polydispersity of 1.98, 56% butyl, 44% amino), which is supplied by Solutia Inc., St. Louis, Mo., or Cymel®1158 provided by Cytec Industries Inc., West Patterson, N.J. Cytec Industries Inc. also supplies Cymel® 1130@80 percent solids (degree of polymerization of 2.5), Cymel® 1133 (48% methyl, 4% methylol and 48% butyl), both of which are polymeric melamines. It is also contemplated that, in various non-limiting embodiments, all values and ranges of values, both whole and fractional, including and between those set forth above, are hereby expressly contemplated for use herein.

The composition may include the melamine resin in an amount of from about 0.1 to about 50, alternatively from about 1 to about 20, or alternatively from about 1 to about 10, wt. %, based on a total weight of the composition. In exemplary embodiments, the composition includes a melamine-formaldehyde resin having the tradename Cymel® 303 which is commercially available from Cytec Industries Inc. of West Patterson, N.J. It is also contemplated that, in various non-limiting embodiments, all values and ranges of values, both whole and fractional, including and between those set forth above, are hereby expressly contemplated for use herein.

In still other embodiments, the binder may include a polymer that has a crosslinkable-functional group, such as an isocyanate-reactive group. The term “crosslinkable-functional group” refers to functional groups that are positioned in the oligomer, in the polymer, in the backbone of the polymer, in the pendant from the backbone of the polymer, terminally positioned on the backbone of the polymer, or combinations thereof, wherein these functional groups are capable of crosslinking with crosslinking-functional groups (during the curing step) to produce a coating in the form of crosslinked structures. Typical crosslinkable-functional groups can include hydroxyl, thiol, isocyanate, thioisocyanate, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable-functional groups.

The composition may include a polyester-polyurethane polymer, a latex polymer, a melamine resin, or combinations thereof. It is to be appreciated that other polymers may be included in the composition.

The polyester of the polyester-polyurethane polymer may be linear or branched. Useful polyesters can include esterification products of aliphatic or aromatic dicarboxylic acids, polyols, diols, aromatic or aliphatic cyclic anhydrides and cyclic alcohols. Non-limiting examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further non-limiting examples of suitable polycarboxylic acids can include aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols can also be suitable.

Non-limiting suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. If desired, monohydric alcohols, such as, for example, butanol, octanol, lauryl alcohol, ethoxylated or propoxylated phenols may also be included along with polyhydric alcohols to control the molecular weight.

Non-limiting examples of suitable polyesters include a branched copolyester polymer. The branched copolyester polymer and process for production described in U.S. Pat. No. 6,861,495, which is hereby incorporated by reference, can be suitable. Monomers with multifunctional groups such as AxBy (x, y=1 to 3, independently) types including those having one carboxyl group and two hydroxyl groups, two carboxyl groups and one hydroxyl group, one carboxyl group and three hydroxyl groups, or three carboxyl groups and one hydroxyl group can be used to create branched structures. Non-limiting examples of such monomers include 2,3 dihydroxy propionic acid, 2,3 dihydroxy 2-methyl propionic acid, 2,2 dihydroxy propionic acid, 2,2-bis(hydroxymethyl) propionic acid, and the like.

The branched copolyester polymer can be conventionally polymerized from a monomer mixture containing a chain extender selected from the group of a hydroxy carboxylic acid, a lactone of a hydroxy carboxylic acid, and a combination thereof; and one or more branching monomers. Some of the suitable hydroxy carboxylic acids include glycolic acid, lactic acid, 3-hydroxypropionic acid, 3-hydroxybutyric acid, 3-hydroxyvaleric acid, and hydroxypyvalic acid. Some of the suitable lactones include caprolactone, valerolactone; and lactones of the corresponding hydroxy carboxylic acids, such as, e.g., 3-hydroxypropionic acid, 3-hydroxybutyric acid, 3-hydroxyvaleric acid, and hydroxypyvalic acid. In various embodiments, caprolactone can is utilized. In various embodiments, the branched copolyester polymer can be produced by polymerizing, in one step, the monomer mixture that includes the chain extender and hyper branching monomers, or by first polymerizing the hyper branching monomers followed by polymerizing the chain extenders. It is to be appreciated that the branched copolyester polymer can be formed from acrylic core with extending monomers described above.

The polyester-polyurethane polymer can be produced from the polyester and polyisocyanates. The polyester can be polymeric or oligomeric organic species with at least two hydroxyl-functionalities or two-mercapto functionalities and their mixtures thereof. Polyesters and polycarbonates with terminal hydroxy groups can be effectively used as the diols.

The polyurethane polymers may be produced by reacting polyisocyanate(s) with polyol(s) in the excess. In various embodiments, low molar mass polyols defined by an empirical and structural formula, such as polyhydric alcohols are utilized to form the polyurethane polymer. Non-limiting examples of polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. In other embodiments, oligomeric or polymeric polyols with number-average molar masses of, for example, up to about 8000, alternatively up to about 5000, alternative up to about 2000, and/or, for example, corresponding hydroxyl-functional polyethers, polyesters or polycarbonates are utilized to form the polyurethane polymer. It is also contemplated that, in various non-limiting embodiments, all values and ranges of values, both whole and fractional, including and between those set forth above, are hereby expressly contemplated for use herein.

Non-limiting examples of suitable polyisocyanates include aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate. Other polyisocyanates disclosed herein can also be suitable for producing polyurethanes.

In various embodiments, the binder includes an elastomeric resin in an amount of at least about 50 weight %, wherein the elastomeric resin has an Elongation to Break of at least about 500% according to DIN 53 504. The binder may have a Tg of less than about 0° C. In various embodiments, the elastomeric resin is selected from the group of the elastomer is selected from the group of polyesters, polyurethanes, acrylics, and combinations thereof.

### Pigments

The composition may also include a primary pigment, e.g. present in an amount of from about 0.1 to about 20 weight % based on a total weight of the composition. In various embodiments, the primary pigment is present in an amount of from about 1 to about 20, about 2 to about 18, about 4 to about 16, about 6 to about 14, about 8 to about 12, about 5 to about 10, about 10 to about 15, about 5 to about 15, about 15 to about 20, about 10 to about 20, about 0.1 to about 1, about 0.1 to about 0.5, or about 0.5 to about 1, weight % based on a total weight of the composition. It is also contemplated that, in various non-limiting embodiments, all values and ranges of values, both whole and fractional, including and between those set forth above, are hereby expressly contemplated for use herein.

Non-limiting examples of suitable primary pigments include pigments with coloristic properties including: blue pigments including indanthrone blue Pigment Blue 60, phthalocyanine blues, Pigment Blue 15:1, 15, 15:3 and 15:4, and cobalt blue Pigment Blue 28; red pigments including quinacridone reds, Pigment Red 122 and Pigment Red 202, iron oxide red Pigment Red 101, perylene reds scarlet Pigment Red 149, Pigment Red 177, Pigment Red 178, and maroon Pigment Red 179, azoic red Pigment Red 188, and diketo-pyrrolopyrrol reds Pigment red 255 and Pigment Red 264; yellow pigments including diarylide yellows Pigment Yellow 14, iron oxide yellow Pigment Yellow 42, nickel titanate yellow Pigment Yellow 53, indolinone yellows Pigment Yellow 110 and Pigment Yellow 139, monoazo yellow Pigment yellow 150, bismuth vanadium yellow pigment Yellow 184, diazo yellows Pigment Yellow 128 and Pigment Yellow 155; orange pigments including quinacridone orange pigments Pigment Yellow 49 and Pigment Orange 49, benzimidazolone orange pigment; Pigment Orange 36; green pigments including phthalocyanine greens Pigment Green 7 and Pigment Green 36, and cobalt green Pigment Green 50; violet pigments including quinacridone violets Pigment Violet 19 and Pigment Violet 42, dioxane violet Pigment Violet 23, and perylene violet Pigment Violet 29; brown pigments including monoazo brown Pigment Brown 25 and chrome-antimony titanate Pigment Brown 24, iron chromium oxide Pigment Brown 29; white pigments such as anatase and rutile titanium dioxide (TiO2) Pigment White 6; and black pigments including carbon blacks Pigment Black 6 and Pigment Black 7, perylene black Pigment Black 32, copper chromate black Pigment Black 28. Alternatively, the primary pigment may be or include metallic oxides, metal hydroxide, effect pigments including metal flakes, chromates, such as lead chromate, sulfides, sulfates, carbonates, carbon black, silica, talc, china clay, phthalocyanine blues and greens, organo reds, organo maroons, pearlescent pigments, other organic pigments and dyes, and combinations thereof. If desired, chromate-free pigments, such as barium metaborate, zinc phosphate, aluminum triphosphate and combinations thereof, can also be utilized.

The composition may also include, or be free of, an effect pigment. The effect pigment may be chosen from metallic flake pigments, mica-containing pigments, glass-containing pigments, and combinations thereof. Further non-limiting examples of suitable effect pigments include bright aluminum flake, extremely fine aluminum flake, medium particle size aluminum flake, and bright medium coarse aluminum flake; mica flake coated with titanium dioxide pigment also known as pearl pigments; and combinations thereof. Non-limiting examples of suitable colored pigments include titanium dioxide, zinc oxide, iron oxide, carbon black, mono azo red toner, red iron oxide, quinacridone maroon, transparent red oxide, dioxazine carbazole violet, iron blue, indanthrone blue, chrome titanate, titanium yellow, mono azo permanent orange, ferrite yellow, mono azo benzimidazolone yellow, transparent yellow oxide, isoindoline yellow, tetrachloroisoindoline yellow, anthanthrone orange, lead chromate yellow, phthalocyanine green, quinacridone red, perylene maroon, quinacridone violet, pre-darkened chrome yellow, thio-indigo red, transparent red oxide chip, molybdate orange, molybdate orange red, and combinations thereof.

The composition may further include, or be free of, a functional pigment. The functional pigment may be selected from radar reflective pigments, LiDAR reflective pigments, corrosion inhibiting pigments, and combinations thereof.

The composition may further include, or be free of, an extender pigment. While extender pigments are generally utilized to replace higher cost pigments in compositions, the extender pigments as contemplated herein may increase shear viscosity of the composition as compared to a composition free of the extender pigments. An increase in shear viscosity of the composition may improve suitability of the composition for application to the substrate utilizing the non-contact deposition applicator. The extender pigment may have a particle size of from about 0.01 to about 44 microns. The extender pigment may have a variety of configurations including, but not limited to, nodular, platelet, acicular, and fibrous. Non-limiting examples of suitable extender pigments include whiting, barytes, amorphous silica, fumed silica, diatomaceous silica, china clay, calcium carbonate, phyllosilicate (mica), wollastonite, magnesium silicate (talc), barium sulfate, kaolin, and aluminum silicate. It is also contemplated that, in various non-limiting embodiments, all values and ranges of values, both whole and fractional, including and between those set forth above, are hereby expressly contemplated for use herein.

The composition may include the extender pigment in an amount of from about 0.1 to about 50, alternatively from about 1 to about 20, or alternatively from about 1 to about 10, wt. %, based on a total weight of the composition. In various embodiments, the composition includes magnesium silicate (talc), barium sulfate, or a combination thereof. In various embodiments, inclusion of barium sulfate as the extender pigment results in a composition having greater shear viscosity as compared to inclusion of talc as the extender pigment. It is also contemplated that, in various non-limiting embodiments, all values and ranges of values, both whole and fractional, including and between those set forth above, are hereby expressly contemplated for use herein.

### Crosslinking Agent

The composition may also include a crosslinking agent, e.g. present in an amount of from about 0.1 to about 25 weight % based on a total weight of the composition. In various embodiments, the composition includes the crosslinking agent in an amount of from about 1 to about 25, about 1 to about 20, about 2 to about 18, about 4 to about 16, about 6 to about 14, about 8 to about 12, about 5 to about 10, about 10 to about 15, about 5 to about 15, about 15 to about 20, about 10 to about 20, about 5 to about 25, about 10 to about 25, about 15 to about 25, about 20 to about 25, about 0.1 to about 1, about 0.1 to about 0.5, or about 0.5 to about 1, weight % based on a total weight of the composition. It is also contemplated that, in various non-limiting embodiments, all values and ranges of values, both whole and fractional, including and between those set forth above, are hereby expressly contemplated for use herein.

The crosslinking agent, i.e., crosslinker, typically can react with crosslinkable-functional groups of the binder to form a crosslinked polymeric network, herein referred to as a crosslinked network. It is to be appreciated that the crosslinking agent is not necessary in all compositions, but may be utilized in the composition to improve inter-coat adhesion in automotive coatings, such as between a basecoat and a clearcoat, and for curing, such as within the clearcoat. That said, it is contemplated that a composition may be free of a crosslinking agent.

The term “crosslinking agent” typically describes a component having “crosslinking-functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable-functional groups (during the curing step) to produce a coating in the form of crosslinked structures. One of ordinary skill in the art would recognize that certain combinations of crosslinking-functional group and crosslinkable-functional groups would be excluded, since they would fail to crosslink and produce the film forming crosslinked structures. The composition may include more than one type of crosslinking agent that have the same or different crosslinking-functional groups. Typical crosslinking-functional groups can include hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide, or combinations thereof.

Polyisocyanates having isocyanate-functional groups may be utilized as the crosslinking agent to react with the crosslinkable-functional groups, such as hydroxyl-functional groups and amine-functional groups. In various embodiments, only primary and secondary amine-functional groups may be reacted with the isocyanate-functional groups. Suitable polyisocyanate can have on average about 2 to about 10, alternately about 2.5 to about 8, or alternately about 3 to about 8, isocyanate functionalities. Typically, the composition has a ratio of isocyanate-functional groups on the polyisocyanate to crosslinkable-functional group (e.g., hydroxyl and/or amine groups), of from about 0.25:1 to about 3:1, alternatively from about 0.8:1 to about 2:1, or alternatively from about 1:1 to about 1.8:1. In other embodiments, melamine compounds having melamine-functional groups may be utilized as the crosslinking agent to react with the crosslinkable-functional groups. It is also contemplated that, in various non-limiting embodiments, all values and ranges of values, both whole and fractional, including and between those set forth above, are hereby expressly contemplated for use herein.

Non-limiting examples of suitable polyisocyanates include any of the conventionally used aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of 2 molecules of a diisocyanate, such as, hexamethylene diisocyanate; uretidiones of hexamethylene diisocyanate; uretidiones of isophorone diisocyanate or isophorone diisocyanate; isocyanurate of meta-tetramethylxylylene diisocyanate; and a diol such as, ethylene glycol.

Polyisocyanate-functional adducts having isocyanaurate structural units can also be used, for example, the adduct of 2 molecules of a diisocyanate, such as, hexamethylene diisocyanate or isophorone diisocyanate, and a diol such as ethylene glycol; the adduct of 3 molecules of hexamethylene diisocyanate and 1 molecule of water (commercially available from Bayer Corporation of Pittsburgh, Pa. under the trade name Desmodur® N); the adduct of 1 molecule of trimethylol propane and 3 molecules of toluene diisocyanate (commercially available from Bayer Corporation of Pittsburgh, Pa. under the trade name Desmodur® L); the adduct of 1 molecule of trimethylol propane and 3 molecules of isophorone diisocyanate or compounds, such as 1,3,5-triisocyanato benzene and 2,4,6-triisocyanatotoluene; and the adduct of 1 molecule of pentaerythritol and 4 molecules of toluene diisocyanate.

The composition may include or be free of monomeric, oligomeric, or polymeric compounds that are curable by ultraviolet (UV), electron beam (EB), laser, and the like. Placement of a UV, EB, or laser source on the non-contact deposition applicator may result in direct photo initiation of each droplet that is applied to the substrate by the non-contact deposition applicator. The increase in use of monomers relative to polymers can increase the curable solids of the composition without increasing the viscosity of the composition thereby reducing the volatile organic carbons (VOCs) released into the environment. However, the increase in use of monomers relative to polymers may impact one or more properties of the composition. Adjustment of the properties of the composition may be necessary to render the composition suitable for application utilizing the non-contact deposition applicator including, but not limited to, viscosity (η₀), density (ρ), surface tension (α), and relaxation time (λ). Further, adjustment of properties of the non-contact deposition applicator may be necessary to render the non-contact deposition applicator suitable for application, including, but not limited to, nozzle diameter (D) of the non-contact deposition applicator, impact velocity (v) of the composition by the non-contact deposition applicator, speed of the non-contact deposition applicator, distance of the non-contact deposition applicator from the substrate, droplet size of the composition by the non-contact deposition applicator, firing rate of the non-contact deposition applicator, and orientation of the non-contact deposition applicator relative to the force of gravity.

### Additional Components

The composition can also include, or be free of, various additional components, such as dyes, rheology modifiers, catalysts, conventional additives, or combinations thereof. Conventional additives may include, but are not limited to, dispersants, antioxidants, UV stabilizers and absorbers, surfactants, wetting agents, leveling agents, antifoaming agents, anti-cratering agents, or combinations thereof. In various embodiments, the composition is suitable for application to the substrate utilizing the non-contact deposition applicator on the basis that the composition includes certain components and/or includes certain components in a specific amount/ratio.

In various embodiments, the composition further includes or is free of a corrosion inhibiting pigment. Any corrosion inhibiting pigment known in the art may be utilized such as Calcium Strontium Zinc Phosphosilicate. In other embodiments, double orthophosphates, in which one of the cations is represented by zinc can be used. For example, these may include Zn—Al, Zn—Ca, but also Zn—K, Zn—Fe, Zn—Ca—Sr or Ba—Ca and Sr—Ca combinations. It is possible to combine a phosphate anion with further anticorrosively efficient anions, such as silicate, molybdate, or borate. Modified phosphate pigments can be modified by organic corrosion inhibitors. Modified phosphate pigments can be exemplified by the following compounds: Aluminum(III) zinc(II) phosphate, Basic zinc phosphate, Zinc phosphomolybdate, Zinc calcium phosphomolybdate, Zinc borophosphate. Moreover, Zinc strontium phosphosilicate, Calcium barium phosphosilicate, Calcium strontium zinc phosphosilicate, and combinations thereof. Zinc 5-nitroisophthalate, Calcium 5-nitroisophthalate, Calcium cyanurate, metal salts of dinonylnaphthalene sulfonic acids, and combinations thereof can also be used.

The composition may include a corrosion inhibiting pigment in an amount of from about 3 wt. % to about 12 wt. % based on a total weight of the composition. In various embodiments, the coating layer formed from the composition has a corrosion resistance as demonstrated by no more than about 10 mm creep from scribe after about 500 hours salt spray per ASTM B117. The substrate may define a target area and a non-target area adjacent the target area. The non-contact deposition applicator may be configured to expel the composition through the nozzle orifice to the target area to form a coating layer having corrosion resistance as demonstrated by no more than about 10 mm creep from scribe after about 500 hours salt spray per ASTM B117. It is also contemplated that, in various non-limiting embodiments, all values and ranges of values, both whole and fractional, including and between those set forth above, are hereby expressly contemplated for use herein.

The composition may include elastomeric polymers and additives resulting in a coating layer exhibiting increased stone chip resistance. The elastomeric polymers and additives may impact one or more properties of the composition.

In various embodiments, the composition includes or is free of LiDAR-reflective pigment that, when formed into a coating layer, may improve recognition of the substrate by LiDAR. The size of coating layer formed from the composition including LiDAR-reflective pigment may be just large enough to be recognized by LiDAR while still maintaining the appearance provided by the conventional coating. Further, the composition including LiDAR-reflective pigment may be applied to specific locations on the vehicle (e.g., bumper, roof line, hood, side panel, mirrors, etc.) that are relevant to recognition by LiDAR while still maintaining the appearance provided by the conventional coating. The composition including LiDAR-reflective pigment may be any composition, such as a basecoat or a clear coat. The composition including LiDAR-reflective pigment may be applied to the substrate by the non-contact deposition applicator in a pre-defined location without the need for masking the substrate and wasting a portion of the composition including LiDAR-reflective pigment through low-transfer efficiency application methods, such as conventional spray atomization.

The LiDAR-reflective pigment may impact one or more properties of the composition. In various embodiments, the composition includes or is free of a radar reflective pigment or a LiDAR reflective pigment. In various embodiments, the radar reflective pigment or the LiDAR reflective pigment may include, but is not limited to, Nickel manganese ferrite blacks (Pigment Black 30) and iron chromite brown-blacks (CI Pigment Green 17, CI Pigment Browns 29 and 35). Other commercially available infrared reflective pigments are Pigment Blue 28 Pigment Blue 36, Pigment Green 26, Pigment Green 50, Pigment Brown 33, Pigment Brown 24, Pigment Black 12 and Pigment Yellow 53. The LiDAR reflective pigment may also be referred to as an infrared reflective pigment.

In various embodiments, the composition includes the LiDAR reflective pigment in an amount of from about 0.1 wt. % to about 5 wt. % based on a total weight of the composition. In various embodiments, the coating layer has a reflectance at a wavelength from about 904 nm to about 1.6 microns. The substrate may define a target area and a non-target area adjacent the target area. The non-contact deposition applicator may be configured to expel the composition through the nozzle orifice to the target area to form a coating layer having a reflectance at a wavelength from about 904 nm to about 1.6 microns. It is also contemplated that, in various non-limiting embodiments, all values and ranges of values, both whole and fractional, including and between those set forth above, are hereby expressly contemplated for use herein.

The composition may further include or be free of dyes. Non-limiting examples of suitable dyes include triphenylmethane dyes, anthraquinone dyes, xanthene and related dyes, azo dyes, reactive dyes, phthalocyanine compounds, quinacridone compounds, and fluorescent brighteners, and combinations thereof. The composition may include the dye in an amount of from about 0.01 to about 5, alternatively from about 0.05 to about 1, or alternatively from about 0.05 to about 0.5, wt. %, based on a total weight of the composition. In various embodiments, the composition includes an about 10% black dye solution, such as Sol. Orasol Negro RL. It is also contemplated that, in various non-limiting embodiments, all values and ranges of values, both whole and fractional, including and between those set forth above, are hereby expressly contemplated for use herein.

The composition may be substantially free of a dye. The term “substantially” as utilized herein means that the composition may include insignificant amounts of dye such that the color and/or properties of the composition are not impacted by the addition of the insignificant amount of the dye which still being considered substantially free of a dye. In various embodiments, the composition being substantially free of a dye includes no greater than about 5 wt. %, alternatively no greater than about 1 wt. %, or alternatively no greater than about 0.1 wt. %. It is also contemplated that, in various non-limiting embodiments, all values and ranges of values, both whole and fractional, including and between those set forth above, are hereby expressly contemplated for use herein.

As also introduced above, the composition may further include or be free of rheology modifiers. Many different types of rheology modifiers can be used in compositions may be utilized in the composition. For example, a rheology modifier can be used that may increase rheology of the composition as compared to a composition free of the rheology modifier. An increase in rheology of the composition may improve suitability of the composition for application to the substrate utilizing the non-contact deposition applicator. Non-limiting examples of suitable rheology modifiers include urea-based compounds, laponite propylene glycol solutions, acrylic alkali emulsions, and combinations thereof. The composition may include the rheology modifier in an amount of from about 0.01 to about 5, alternatively from about 0.05 to about 1, or alternatively from about 0.05 to about 0.5, wt. %, based on a total weight of the composition. In various embodiments, the composition includes the laponite propylene glycol solution, the acrylic alkali emulsion, or a combination thereof. The laponite propylene glycol solution includes a synthetic layered silicate, water, and polypropylene glycol. The synthetic layered silicate is commercially available from Altana AG of Wesel, Germany under the trade name Laponite RD. The acrylic alkali emulsion is commercially available from BASF Corporation of Florham Park, N.J. under the tradename Viscalex® HV 30. It is also contemplated that, in various non-limiting embodiments, all values and ranges of values, both whole and fractional, including and between those set forth above, are hereby expressly contemplated for use herein.

As also introduced above, the composition may further include a catalyst. The composition may further include a catalyst to reduce curing time and to allow curing of the composition at ambient temperatures. The ambient temperatures are typically referred to as temperatures of from about 18° C. to about 35° C. Non-limiting examples of suitable catalysts may include organic metal salts, such as, dibutyl tin dilaurate, dibutyl tin diacetate, dibutyl tin dichloride, dibutyl tin dibromide, zinc naphthenate; triphenyl boron, tetraisopropyl titanate, triethanolamine titanate chelate, dibutyl tin dioxide, dibutyl tin dioctoate, tin octoate, aluminum titanate, aluminum chelates, zirconium chelate, hydrocarbon phosphonium halides, such as, ethyl triphenyl phosphonium iodide and other such phosphonium salts and other catalysts, or a combination thereof. Non-limiting examples of suitable acid catalysts may include carboxylic acids, sulfonic acids, phosphoric acids or a combination thereof. In some embodiments, the acid catalyst can include, for example, acetic acid, formic acid, dodecyl benzene sulfonic acid, dinonyl naphthalene sulfonic acid, para-toluene sulfonic acid, phosphoric acid, or a combination thereof. The composition may include the catalysts in an amount of from about 0.01 to about 5, alternatively from about 0.05 to about 1, or alternatively from about 0.05 to about 0.5, wt. %, based on a total weight of the composition. It is also contemplated that, in various non-limiting embodiments, all values and ranges of values, both whole and fractional, including and between those set forth above, are hereby expressly contemplated for use herein.

As also introduced above, the composition may further include conventional additives. The composition may further include an ultraviolet light stabilizer. Non-limiting examples of such ultraviolet light stabilizers include ultraviolet light absorbers, screeners, quenchers, and hindered amine light stabilizers. An antioxidant can also be added to the composition. Typical ultraviolet light stabilizers can include benzophenones, triazoles, triazines, benzoates, hindered amines and mixtures thereof. A blend of hindered amine light stabilizers, such as Tinuvin® 328 and Tinuvin®123, all commercially available from Ciba Specialty Chemicals of Tarrytown, N.Y., under the trade name Tinuvin®, can be utilized.

Non-limiting examples of suitable ultraviolet light absorbers include hydroxyphenyl benzotriazoles, such as, 2-(2-hydroxy-5-methylphenyl)-2H-benzotrazole, 2-(2-hydroxy-3,5-di-tert.amyl-phenyl)-2H-benzotriazole, 2[2-hydroxy-3,5-di(1,1-dimethylbenzyl)phenyl]-2H-benzotriazole, reaction product of 2-(2-hydroxy-3-tert.butyl-5-methyl propionate)-2H-benzotriazole and polyethylene ether glycol having a weight average molecular weight of 300, 2-(2-hydroxy-3-tert.butyl-5-iso-octyl propionate)-2H-benzotriazole; hydroxyphenyl s-triazines, such as, 2-[4((2,-hydroxy-3-dodecyloxy/tridecyloxypropyl)-oxy)-2-hydroxyphenyl]-4,6-bis(2,4-dimethylphenyl)-1,3,5-triazine, 2-[4(2-hydroxy-3-(2-ethylhexyl)-oxy)-2-hydroxyphenyl]-4,6-bis(2,4-dimethylphenyl)1,3,5-triazine, 2-(4-octyloxy-2-hydroxyphenyl)-4,6-bis(2,4-dimethylphenyl)-1,3,5-triazine; hydroxybenzophenone U.V. absorbers, such as, 2,4-dihydroxybenzophenone, 2-hydroxy-4-octyloxybenzophenone, and 2-hydroxy-4-dodecyloxybenzophenone.

Non-limiting examples of suitable hindered amine light stabilizers include N-(1,2,2,6,6-pentamethyl-4-piperidinyl)-2-dodecyl succinimide, N(1acetyl-2,2,6,6-tetramethyl-4-piperidinyl)-2-dodecyl succinimide, N-(2hydroxyethyl)-2,6,6,6-tetramethylpiperidine-4-ol-succinic acid copolymer, 1,3,5 triazine-2,4,6-triamine, N,N′″-[1,2-ethanediybis[[[4,6-bis[butyl(1,2,2,6,6-pentamethyl-4-piperidinyl)amino]-1,3,5-triazine-2-yl]imino]-3,1-propanediyl]]bis[N, N′″-dibutyl-N′,N′″-bis(1,2,2,6,6-pentamethyl-4-piperidinyl)], poly-[[6-[1,1,3,3-tetramethylbutyl)-amino]-1,3,5-trianzine-2,4-diyl][2,2,6,6-tetramethylpiperidinyl)-imino]-1,6-hexane-diyl[(2,2,6,6-tetramethyl-4-piperidinyl)-imino]), bis(2,2,6,6-tetramethyl-4-piperidinyl)sebacate, bis(1,2,2,6,6-pentamethyl-4-piperidinyl)sebacate, bis(1-octyloxy-2,2,6,6-tetramethyl-4-piperidinyl)sebacate, bis(1,2,2,6,6-pentamethyl-4-piperidinyl)[3,5bis(1,1-dimethylethyl-4-hydroxy-phenyl)methyl]butyl propanedioate, 8-acetyl-3-dodecyl-7,7,9,9,-tetramethyl-1,3,8-triazaspiro(4,5)decane-2,4-dione, and dodecyl/tetradecyl-3-(2,2,4,4-tetramethyl-21-oxo-7-oxa-3,20-diazal dispiro(5.1.11.2)henicosan-20-yl)propionate.

Non-limiting examples of suitable antioxidants include tetrakis[methylene(3,5-di-tert-butylhydroxy hydrocinnamate)]methane, octadecyl 3,5-di-tert-butyl-4-hydroxyhydrocinnamate, tris(2,4-di-tert-butylphenyl) phosphite, 1,3,5-tris(3,5-di-tert-butyl-4-hydroxybenzyl)-1,3,5-triazine-2,4,6(1H,3H,5H)-trione and benzenepropanoic acid, 3,5-bis(1,1-dimethyl-ethyl)-4-hydroxy-C7-C9 branched alkyl esters. In various embodiments, the antioxidant includes hydroperoxide decomposers, such as Sanko® HCA (9,10-dihydro-9-oxa-10-phosphenanthrene-10-oxide), triphenyl phosphate and other organo-phosphorous compounds, such as, Irgafos® TNPP from Ciba Specialty Chemicals, Irgafos® 168 from Ciba Specialty Chemicals, Ultranox®626 from GE Specialty Chemicals, Mark PEP-6 from Asahi Denka, Mark HP-10 from Asahi Denka, Irgafos® P-EPQ from Ciba Specialty Chemicals, Ethanox 398 from Albemarle, Weston 618 from GE Specialty Chemicals, Irgafos® 12 from Ciba Specialty Chemicals, Irgafos® 38 from Ciba Specialty Chemicals, Ultranox® 641 from GE Specialty Chemicals, and Doverphos® S-9228 from Dover Chemicals.

The composition may further include other additives such as wetting agents, leveling and flow control agents, for example, Resiflow®S (polybutylacrylate), BYK® 320 and 325 (high molecular weight polyacrylates), BYK® 347 (polyether-modified siloxane) under respective trade names, leveling agents based on (meth)acrylic homopolymers; rheological control agents; thickeners, such as partially crosslinked polycarboxylic acid or polyurethanes; and antifoaming agents. The other additives can be used in conventional amounts familiar to those skilled in the art. In various embodiments, the wetting agents, leveling agents, flow control agents, and surfactants of the composition can affect the surface tension of the composition and thus may have an impact on the suitability of the composition for printing. Certain wetting agents, leveling agents, flow control agents, and surfactants may be incorporated into the composition for increasing or decreasing the surface tension of the composition.

### Additional Physical Properties

Any of the aforementioned compounds or additional components may be utilized to adjust physical properties of the composition to render the composition suitable for application utilizing the non-contact deposition applicator including, but not limited to, viscosity (η₀), density (ρ), surface tension (σ), and relaxation time (λ). Further, adjustment of properties of the non-contact deposition applicator may be necessary to render the non-contact deposition applicator suitable for application, including, but not limited to, nozzle diameter (D) of the non-contact deposition applicator, impact velocity (v) of the composition by the non-contact deposition applicator, speed of the non-contact deposition applicator, distance of the non-contact deposition applicator from the substrate, droplet size of the composition by the non-contact deposition applicator, firing rate of the non-contact deposition applicator, and orientation of the non-contact deposition applicator relative to the force of gravity.

In various embodiments, and as introduced above, the composition is described as exhibiting properties such as viscosity (η₀), density (ρ), surface tension (σ), and relaxation time (λ). Further, the composition as applied typically forms a coating layer having precise boundaries, improved hiding, and reduced drying time. In various embodiments, the composition exhibits non-Newtonian fluid behavior which is in contrast to conventional ink.

In view of the various properties of the composition and the non-contact deposition applicator, one or more relationships may be established between these properties for forming the composition having properties suitable for application utilizing the non-contact deposition applicator. In various embodiments, various equations may be applied to one or more of these properties of the composition and the non-contact deposition applicator to determine boundaries for these properties rendering the composition suitable for application utilizing the non-contact deposition applicator. In various embodiments, the boundaries for the properties of the composition may be determined by establishing an Ohnesorge number (Oh) for the composition, a Reynolds number (Re) for the composition, a Deborah number (De) for the composition, or combinations thereof.

In various embodiments, the Ohnesorge number (Oh) is a dimensionless constant that generally relates to the tendency for a drop of the composition, upon contact with the substrate, to either remain as a single drop or separate into many droplets (i.e., satellite droplets), by considering viscous and surface tension forces of the composition. The Ohnesorge number (Oh) may be determined in accordance with equation I, as follows:

Oh=(η/\sqrt{ρσD}) (I),

wherein η represents viscosity of the composition in pascal-seconds (Pa*s), ρ represents density of the composition in kilograms per cubic meter (kg/m³), σ represents surface tension of the composition in newtons per meter (N/m), and D represents nozzle diameter of the non-contact deposition applicator in meters (m). The Ohnesorge number (Oh) may be of from about 0.01 to about 50, alternatively from about 0.05 to about 10, or alternatively from about 0.1 to about 2.70. The Ohnesorge number (Oh) may be at least about 0.01, alternatively at least about 0.05, or alternatively at least about 0.1. The Ohnesorge number (Oh) may be no greater than about 50, alternatively no greater than about 10, or alternatively no greater than about 2.70. It is also contemplated that, in various non-limiting embodiments, all values and ranges of values, both whole and fractional, including and between those set forth above, are hereby expressly contemplated for use herein.

In various embodiments, the Reynolds number (Re) is a dimensionless constant that generally relates to the flow pattern of the composition and, in various embodiments, relates to flow patterns extending between laminar flow and turbulent flow by considering viscous and inertial forces of the composition. The Reynolds number (Re) may be determined in accordance with equation II, as follows:

Re=(ρvD/η) (II),

wherein ρ represents density of the composition in kg/m³, v represents impact velocity of the non-contact deposition applicator in meters per second (m/s), D represents nozzle diameter of the non-contact deposition applicator in m, and η represents viscosity of the composition in Pa*s. The Reynolds number (Re) may be of from about 0.01 to about 1,000, alternatively from about 0.05 to about 500, or alternatively from about 0.34 to about 258.83. The Reynolds number (Re) may be at least about 0.01, alternatively at least about 0.05, or alternatively at least about 0.34. The Reynolds number (Re) may be no greater than about 1,000, alternatively no greater than about 500, or alternatively no greater than about 258.83. It is also contemplated that, in various non-limiting embodiments, all values and ranges of values, both whole and fractional, including and between those set forth above, are hereby expressly contemplated for use herein.

In other embodiments, the Deborah number (De) is a dimensionless constant that generally relates to the elasticity of the composition and, in various embodiments, relates to structure of a visco-elastic material by considering relaxation time of the composition. The Deborah number (De) may be determined in accordance with equation III, as follows:

De=λ/\sqrt{ρD³/σ} (III),

wherein X represents relaxation time of the composition in seconds (s), ρ represents density of the composition in kg/m³, D represents nozzle diameter of the non-contact deposition applicator in m, and a represents surface tension of the composition in N/m. The Deborah number (De) may be of from about 0.01 to about 2,000, alternatively from about 0.1 to about 1,000, or alternatively from about 0.93 to about 778.77. The Deborah number (De) may be at least about 0.01, alternatively at least about 0.1, or alternatively at least about 0.93. The Deborah number (De) may be no greater than about 2,000, alternatively no greater than about 1,000, or alternatively no greater than about 778.77. It is also contemplated that, in various non-limiting embodiments, all values and ranges of values, both whole and fractional, including and between those set forth above, are hereby expressly contemplated for use herein.

In other embodiments, the Weber number (We) is a dimensionless constant that generally relates to fluid flows where there is an interface between two different. The Weber number (We) may be determined in accordance with equation IV, as follows:

We=(Dv²φ/σ (IV),

wherein D represents nozzle diameter of the non-contact deposition applicator in m, v represents impact velocity of the non-contact deposition applicator in meters per second (m/s), ρ represents density of the composition in kg/m³, and σ represents surface tension of the composition in N/m. The Deborah number (De) may be of from greater than about 0 up to about 16,600, alternatively from about 0.2 to about 1,600, or alternatively from about 0.2 to about 10. The Deborah number (We) may be at least about 0.01, alternatively at least about 0.1, or alternatively at least about 0.2. The Deborah number (De) may be no greater than about 16,600, alternatively no greater than about 1,600, or alternatively no greater than about 10. It is also contemplated that, in various non-limiting embodiments, all values and ranges of values, both whole and fractional, including and between those set forth above, are hereby expressly contemplated for use herein.

In various embodiments, the composition has an Ohnesorge number (Oh) of from about 0.01 to about 12.6, alternatively from about 0.05 to about 1.8, or alternatively about 0.38. The composition may have a Reynolds number (Re) of from about 0.02 to about 6,200, alternatively from about 0.3 to about 660, or alternatively about 5.21. The composition may have a Deborah number (De) of from greater than about 0 up to about 1730, alternatively from greater than about 0 up to about 46, or alternatively about 1.02. The composition may have a Weber number (We) of from greater than about 0 up to about 16,600, alternatively from about 0.2 to about 1,600, or alternatively about 3.86. It is also contemplated that, in various non-limiting embodiments, all values and ranges of values, both whole and fractional, including and between those set forth above, are hereby expressly contemplated for use herein.

In view of one or more of the equations described above, the composition may have a viscosity (η) in an amount of from about 0.001 to about 1, alternatively from about 0.005 to about 0.1, or alternatively from about 0.01 to about 0.06, pascal-seconds (Pa·s). The composition may have a viscosity (η) in an amount of at least about 0.001, alternatively at least about 0.005, or alternatively at least about 0.01, Pa·s. The composition may have a viscosity (η) in an amount of no greater than 1, alternatively no greater than 0.1, or alternatively no greater than about 0.06, Pa·s. The viscosity (η) may be determined in accordance with ASTM D2196-15. The viscosity (η) is determined at a high shear viscosity of 10,000 reciprocal seconds (1/sec). Printing a non-Newtonian fluid is generally represented at the high shear viscosity of 10,000 1/sec. It is also contemplated that, in various non-limiting embodiments, all values and ranges of values, both whole and fractional, including and between those set forth above, are hereby expressly contemplated for use herein.

Further, in view of one or more of the equations described above, the composition may have a density (ρ) in an amount of from about 700 to about 1500, alternatively from about 800 to about 1400, or alternatively from about 1030 to about 1200, kilograms per cubic meter (kg/m³). The composition may have a density (ρ) in an amount of at least about 700, alternatively at least about 800, or alternatively at least about 1030, kg/m³. The composition may have a density (ρ) in an amount of no greater than about 1500, alternatively no greater than about 1400, or alternatively no greater than about 1200, kg/m³. The density (ρ) may be determined in accordance with ASTM D1475. It is also contemplated that, in various non-limiting embodiments, all values and ranges of values, both whole and fractional, including and between those set forth above, are hereby expressly contemplated for use herein.

Also, in view of one or more of the equations described above, the composition may have a surface tension (σ) in an amount of from about 0.001 to about 1, alternatively from about 0.01 to about 0.1, or alternatively from about 0.024 to about 0.05, newtons per meter (N/m). The composition may have a surface tension (σ) in an amount of at least about 0.001, alternatively at least about 0.01, or alternatively at least about 0.015, N/m. The composition may have a surface tension (σ) in an amount of no greater than about 1, alternatively no greater than about 0.1, or alternatively no greater than about 0.05, N/m. The surface tension (σ) may be determined in accordance with ASTM D1331-14. It is also contemplated that, in various non-limiting embodiments, all values and ranges of values, both whole and fractional, including and between those set forth above, are hereby expressly contemplated for use herein.

Moreover, in view of one or more of the equations described above, the composition may have a varying relaxation time (λ). Relaxation time can refer to a time specifically after drop ejection, i.e., how long it would take for the droplet tail to break off from the nozzle and become part of the ejected droplet. If this relaxation time is too long, well defined droplets will not be formed and jetting performance will be poor. However, relative to the instant disclosure, pre-shearing is desired (as described in detail below) such that a low viscosity state is maintained sufficiently long so that a droplet can be successfully ejected from a nozzle. In the instant disclosure, strictly from a droplet ejection perspective, the relaxation time would typically be advantageously made longer. In other words, if pre-shearing could occur in a pot or vessel and the composition could be pumped to a printhead while maintaining a low viscosity during this complete process, such a long relaxation time would be desirable. However, from a coating performance point of view, after droplet ejection, such a long relaxation time would mean the composition might remain at a low viscosity for so long that it would not prevent sagging/slumping. Accordingly, relative to the instant disclosure, a sufficiently long relaxation time is desired such that if the composition is pre-sheared directly before the nozzle, the relaxation time will enable sufficiently low viscosity that allows for jetting. However, the composition must be able to build up viscosity quickly after droplet ejection. If the relaxation time is too short, the composition could relax to such a high viscosity that it would be unusable. For these reasons, a relaxation time of about 0.05 to about 0.2, or about 0.1, is preferred in various embodiments. However, to be clear, such a relaxation time is not required in all embodiments.

The relaxation time (λ) may be determined using any method known in the art. For example, relaxation time (λ) may be determined by a stress relaxation test performed in a strain controlled rheometer wherein a viscoelastic fluid is held between parallel plates and an instantaneous strain is applied to one side of the sample. The other side is held constant while stress (proportional to torque) is being monitored. The resulting stress decay is measured as a function of time yielding stress relaxation modulus (stress divided by applied strain). For many fluids, stress relaxation modulus decays in an exponential fashion with relaxation time as the decay constant. It is also contemplated that, in various non-limiting embodiments, all values and ranges of values, both whole and fractional, including and between those set forth above, are hereby expressly contemplated for use herein.

At least one of the viscosity (η), the surface tension (σ), the density (ρ), or the nozzle diameter (D) may be determined based upon the following equation I in view of the Ohnesorge number (Oh),

Oh=(η/\sqrt{ρσD}) (I).

At least one of the impact velocity (v), the density (ρ), the nozzle diameter D), or the viscosity (η) may be determined based upon the following equation II in view of the Reynolds number (Re).

Re=(ρvD/η) (II).

At least one of the relaxation time (λ), the density (ρ), the nozzle diameter (D), or the surface tension (σ) may be determined based upon the following equation III in view of the Deborah number (De).

De=λ/\sqrt{ρD³/σ} (III).

In various embodiments, the step of obtaining the viscosity (η) of the composition further includes the step of performing a viscosity analysis on the composition according to ASTM 7867-13 with cone-and-plate or parallel plates wherein, when the viscosity is from about 2 to about 200 mPa-s, the viscosity is measured at a 1000 sec-1 shear rate. In various embodiments, the step of obtaining the surface tension (σ) of the composition further includes the step of performing a surface tension analysis on the composition according to ASTM 1331-14. In various embodiments, the step of obtaining the density (ρ) of the composition further includes the step of performing a density analysis on the composition according to ASTM D1475-13. In various embodiments, the step of obtaining the relaxation time (λ) of the composition further includes the step of performing a relaxation time analysis on the composition according to the methods described in Keshavarz B. et al. (2015) Journal of Non-Newtonian Fluid Mechanics, 222, 171-189 and Greiciunas E. et al. (2017) Journal of Rheology, 61, 467. In various embodiments, the step of obtaining the impact velocity (v) of the droplet expelled from the high efficiency transfer applicator further includes the step of performing an impact velocity (v) analysis on the droplet of the composition as the droplet is expelled from the high efficiency transfer applicator when the droplet is within about 2 millimeters distance from the substrate.

Properties of the composition that may render the composition undesirable for application may include, but are not limited to, a too viscous composition, insufficient energy by the non-contact deposition applicator, formation of satellite droplets from the composition, and splashing of the composition.

This disclosure provides additional embodiments of the composition. Any one or more of the components described below may be used in conjunction with, to further define, or to replace any one or more components or compounds described above. It is contemplated that the compositions described above may be substituted with any one or more compounds or compositions described below.

In various embodiments, the composition includes monomeric, oligomeric, or polymeric compounds having a number average molecular weight of from about 400 to about 20,000 and having a free-radically polymerizable double bond. The composition can include a photo initiator. The composition can have an Ohnesorge number (Oh) of from about 0.01 to about 12.6. The composition can also have a Reynolds number (Re) of from about 0.02 to about 6,200. The composition can also have a Deborah number (De) of from greater than about 0 up to about 1730. It is also contemplated that, in various non-limiting embodiments, all values and ranges of values, both whole and fractional, including and between those set forth above, are hereby expressly contemplated for use herein.

The composition may include the monomeric, oligomeric, or polymeric compounds in an amount of from about 20 wt. % to about 90 wt. % based on a total weight of the composition. The composition may include the photo initiator in an amount of from about 0.1 wt. % to about 2 wt. % based on a total weight of the composition. It is to be appreciated that the composition including the monomeric, oligomeric, or polymeric compounds may have up to 100% solids content based on a total weight of the composition. It is also contemplated that, in various non-limiting embodiments, all values and ranges of values, both whole and fractional, including and between those set forth above, are hereby expressly contemplated for use herein.

The composition may be cured in the presence of high-energy radiation. The high-energy radiation may be generated by a device configured to generate ultra violet light, a laser, an electron beam, or combinations thereof. The device may be coupled to the non-contact deposition applicator and configured to direct the high-energy radiation toward the composition.

In various embodiments, the composition is waterborne, and includes about 40 wt % to about 90 wt % water, alternatively about 40 wt % to about 70 wt % water, based on the total weight of the composition. The film forming component of the composition can include any UV curable water-dispersible or latex polymer. A “latex” polymer means a dispersion of polymer particles in water; a latex polymer typically requires a secondary dispersing agent (e.g., a surfactant) for creating a dispersion or emulsion of polymer particles in water. A “water-dispersible” polymer means the polymer is itself capable of being dispersed into water (i.e., without requiring the use of a separate surfactant) or water can be added to the polymer to form a stable aqueous dispersion (i.e., the dispersion should have at least one month shelf stability at normal storage temperatures). Such water-dispersible polymers can include nonionic or anionic functionality on the polymer, which assist in rendering them water-dispersible. For such polymers, external acids or bases are typically required for anionic stabilization. It is also contemplated that, in various non-limiting embodiments, all values and ranges of values, both whole and fractional, including and between those set forth above, are hereby expressly contemplated for use herein.

Suitable UV curable polymers include, but are not limited to, polyurethanes, epoxies, polyamides, chlorinated polyolefins, acrylics, oil-modified polymers, polyesters, and mixtures or copolymers thereof. The UV curable polymers in the composition can include a wide variety of functional groups to modify their properties for a particular application, including, for example, acetoacetyl, (meth)acryl (wherein “(meth)acryl” refers to any of methacryl, methacrylate, acryl or acrylate), vinyl, vinyl ether, (meth)allyl ether (wherein (meth)allyl ether refers to an allyl ether and a methallyl ether), or mixtures thereof.

Acetoacetyl functionality may be incorporated into the UV curable polymer through the use of: acetoacetoxyethyl acrylate, acetoacetoxypropyl methacrylate, allyl acetoacetate, acetoacetoxybutyl methacrylate, 2,3-di(acetoacetoxy)propyl methacrylate, 2-(acetoacetoxy)ethyl methacrylate, t-butyl acetoacetate, diketene, and the like, or combinations thereof. In general, any polymerizable hydroxy functional or other active hydrogen containing monomer can be converted to the corresponding acetoacetyl functional monomer by reaction with diketene or other suitable acetoacetylating agent (see, e.g., Comparison of Methods for the Preparation of Acetoacetylated Coating Resins, Witzeman, J. S.; Dell Nottingham, W.; Del Rector, F. J. Coatings Technology; Vol. 62, 1990, 101 (and references contained therein)). In compositions, the acetoacetyl functional group is incorporated into the polymer via 2-(acetoacetoxy)ethyl methacrylate, t-butyl acetoacetate, diketene, or combinations thereof.

Coating compositions may incorporate a free radically polymerizable component that includes at least one ingredient including free radically polymerizable functionality. Representative examples of free radically polymerizable functionality that is suitable include (meth)acrylate groups, olefinic carbon-carbon double bonds, allyloxy groups, alpha-methyl styrene groups, (meth)acrylamide groups, cyanate ester groups, (meth)acrylonitrile groups, vinyl ethers groups, combinations of these, and the like. The term “(meth)acryl”, as used herein, encompasses acryl and/or methacryl unless otherwise expressly stated. Acryl moieties are may be utilized relative to methacryl moieties in many instances, as acryl moieties tend to cure faster.

Prior to initiating curing, free radically polymerizable groups may provide compositions with relatively long shelf life that resist premature polymerization reactions in storage. At the time of use, polymerization can be initiated on demand with good control by using one or more suitable curing techniques. Illustrative curing techniques include but are not limited to exposure to thermal energy; exposure to one or more types of electromagnetic energy such as visible light, ultraviolet light, infrared light, or the like; exposure to acoustic energy; exposure to accelerated particles such as e-beam energy; contact with chemical curing agents such as by using peroxide initiation with styrene and/or a styrene mimetic; peroxide/amine chemistry; combinations of these; and the like. When curing of such functionality is initiated, crosslinking may proceed relatively rapidly so resultant coatings develop early green strength. Such curing typically proceeds substantially to completion under wide range of conditions to avoid undue levels of leftover reactivity.

In addition to free radically polymerizable functionality, the free radically polymerizable ingredient(s) incorporated into the free radically polymerizable component may include other kinds of functionality, including other types of curing functionality, functionality to promote particle dispersion, adhesion, scratch resistance, chemical resistance, abrasion resistance, combinations of these, and the like. For example, in addition to free radically polymerizable functionality, the free radically polymerizable ingredient(s) may also include additional crosslinkable functionality to allow the composition to form an interpenetrating polymer network upon being cured. One example of such other crosslinkable functionality includes OH and NCO groups, which are co-reactive to form urethane linkages. The reaction between OH and NCO often may be promoted by using a suitable crosslinking agent and catalyst. To help disperse particle additives, particularly ceramic particles, the ingredient(s) of the free radically polymerizable component may include pendant dispersant moieties such as acid or salt moieties of sulfonate, sulfate, phosphonate, phosphate, carboxylate, (meth)acrylonitrile, ammonium, quaternary ammonium, combinations of these, and the like. Other functionality can be selected to promote adhesion, gloss, hardness, chemical resistance, flexibility, and the like. Examples include epoxy, slime, siloxane, alkoxy, ester, amine, amide, urethane, polyester; combinations of these, and the like.

The one or more free radically polymerizable ingredients incorporated into the free radically polymerizable component may be aliphatic and/or aromatic. For outdoor applications, aliphatic materials tend to show better weatherability.

The one or more free radically polymerizable ingredients incorporated into the free radically polymerizable component may be linear, branched, cyclic, fused, combinations of these, or the like. For instance, branched resins may be utilized in some instances, as these resins may tend to have lower viscosity than linear counterparts of comparable molecular weight

In various embodiments, the compositions are fluid dispersions. In such embodiments, the free radically polymerizable component may function as at least a portion of the fluid carrier for particulate ingredients of the compositions. The compositions can be as solvent-free as practical such that the radiation curable component functions as substantially the entirety of the fluid carrier. Some free radically polymerizable ingredients may, by themselves, exist as solids at room temperature, but tend to be readily soluble in one or more of the other ingredients used to provide the free radically polymerizable component. When cured, the resultant matrix serves as a binder for the other ingredients of the composition.

Illustrative embodiments of radiation curable components include a reactive diluent including one or more free radically polymerizable ingredients that have a weight average molecular weight under about 750, alternatively in the range from about 50 to about 750, alternatively from about 50 to about 500. The reactive diluent functions as a diluent, as an agent to reduce the viscosity of the composition, as a coating binder/matrix when cured, as crosslinking agents, and/or the like. It is also contemplated that, in various non-limiting embodiments, all values and ranges of values, both whole and fractional, including and between those set forth above, are hereby expressly contemplated for use herein.

The radiation curable component also optionally includes at least one free radically polymerizable resin in admixture with the reactive diluent. Generally, if the molecular weight of a resin is too large, the compositions may tend to be too viscous for easy handling. This also can impact the appearance of the resultant coating. On the other hand, if the molecular weight is too low, the toughness or resilience of the resultant compositions may suffer. It also can be more difficult to control film thickness, and the resultant coatings may tend to be more brittle than desired. Balancing these concerns, the term resin generally encompasses free radically polymerizable materials having a weight average molecular weight of about 750 or greater, alternatively from about 750 to about 20,000, alternatively about 750 to about 10,000, alternatively about 750 to about 5000, and alternatively about 750 to about 3000. Often, such one or more resins if solid by themselves at about room temperature are soluble in the reactive diluent so that the radiation curable component is a single, fluid phase. As used herein, molecular weight refers to weight average molecular weight unless otherwise expressly stated. It is also contemplated that, in various non-limiting embodiments, all values and ranges of values, both whole and fractional, including and between those set forth above, are hereby expressly contemplated for use herein.

Desirably, the reactive diluent includes at least one ingredient that is mono functional with respect to free radically polymerizable functionality, at least one ingredient that is difunctional with respect to free radically polymerizable functionality, and at least one ingredient that is trifunctional or higher functionality with respect to free radically polymerizable functionality. Reactive diluents including this combination of ingredients help to provide cured coatings with excellent abrasion resistance while maintaining high levels of toughness.

Representative examples of monofunctional, free radically polymerizable ingredients suitable for use in the reactive diluent include styrene, alpha-methylstyrene, substituted styrene, vinyl esters, vinyl ethers, lactams such as N-vinyl-2-pyrrolidone, (meth)acrylamide, N-substituted (meth)acrylamide, octyl(meth)acrylate, nonylphenol ethoxylate(meth)acrylate, isononyl(meth)acrylate, 1,6-hexanediol(meth)acrylate, isobornyl(meth)acrylate, 2-(2-ethoxyethoxy)ethyl(meth)acrylate, 2-ethylhexyl(meth)acrylate, lauryl(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester(meth)acrylate, octodecyl(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like. If one or more of such monofunctional monomers are present, these may include from 0.5 to about 50, alternatively 0.5 to 35, and alternatively from about 0.5 to about 25 weight percent of the radiation curable component based on the total weight of the free radically polymerizable component. It is also contemplated that, in various non-limiting embodiments, all values and ranges of values, both whole and fractional, including and between those set forth above, are hereby expressly contemplated for use herein.

In some embodiments, a monofunctional component of the reactive diluent includes a lactam having pendant free radically polymerizable functionality and at least one other ingredient that is monofunctional with respect to free radical polymerizability. At least one of such additional monofunctional ingredients can have a weight average molecular weight in the range of from about 50 to about 500. The weight ratio of the lactam to the one or more other monofunctional ingredients desirably is in the range from about 1:50 to about 50:1, alternatively 1:20 to about 20:1, alternatively about 2:3 to about 3:2. In one illustrative embodiment, using N-vinyl-2-pyrrolidone and octodecylacrylate at a weight ratio of about 1:1 would provide a suitable monofunctional component of the reactive diluent. It is also contemplated that, in various non-limiting embodiments, all values and ranges of values, both whole and fractional, including and between those set forth above, are hereby expressly contemplated for use herein.

The di, tri, and/or higher functional constituents of the reactive diluent help to enhance one or more properties of the cured composition, including crosslink density, hardness, abrasion resistance, chemical resistance, scratch resistance, or the like. In many embodiments, these constituents may include from 0.5 to about 50, alternatively 0.5 to 35, and alternatively from about 0.5 to about 25 weight percent of the free radically polymerizable component based on the total weight of the free radically polymerizable component. Examples of such higher functional, radiation curable monomers include ethylene glycol di(meth)acrylate, hexanediol di(meth)acrylate, triethylene glycol di(meth)acrylate, tetraethylene glycol di(meth)acrylate, trimethylolpropane tri(meth)acrylate (TMPTA), ethoxylated trimethylolpropane tri(meth)acrylate, glycerol tri(meth)acrylate, pentaerythritol tri(meth)acrylate, pentaerythritol tetra(meth)acrylate, and neopentyl glycol di(meth)acrylate, 1,6 hexanediol di(meth)acrylate, dipentaerythritol penta(meth)acrylate, combinations of these, and the like. Additional free radically polymerizable monomers that would be suitable include those described in PCT Publication No. WO 02/077109, which is incorporated herein by reference in various non-limiting embodiments,

In many embodiments, it is desirable if the reactive diluent includes at least one trifunctional or higher functionality material having a molecular weight in the range from about 50 to about 500 to promote abrasion resistance. The amount of such trifunctional or higher functionality materials used in the reactive diluent may vary over a wide range. In many desirable embodiments, at least about 15 weight percent, alternatively at least about 20 weight percent, at least about 25 weight percent, and even at least about 45 weight percent of the reactive diluent is at least trifunctional or higher with respect to free radically polymerizable functionality based upon the total weight of the reactive diluent. These desirable embodiments incorporate an atypically high amount of tri- or higher functionality for increased crosslink density and corresponding high hardness and scratch resistance, but yet show excellent toughness. It is also contemplated that, in various non-limiting embodiments, all values and ranges of values, both whole and fractional, including and between those set forth above, are hereby expressly contemplated for use herein.

Generally, one would expect that using so much crosslink density would obtain high hardness and scratch resistance at too much expense in terms of toughness and/or resilience. The conventional expectation would be that the resultant compositions to be too brittle to be practical. However, a relatively large content of tri- or higher functionality can be incorporated in the reactive diluent while still maintaining very good levels of toughness and resilience. As discussed below, in some embodiments the diluent materials may be combined along with performance enhancing free radically polymerizable resins, and various selected particles, including ceramic particles, organic particles, certain other additives, and combinations thereof.

The resultant free radically polymerizable components also have rheological properties to support relatively substantial particle distributions. This means that the free radically polymerizable component can be loaded to very high levels with particles and other additives that help to promote desirable characteristics such as scratch resistance, toughness, durability, and the like. In many embodiments, the composite mixture of the free radically polymerizable materials and the particle components may have pseudoplastic and thixotropic properties to help control and promote smoothness, uniformity, aesthetics, and durability of the resultant cured compositions. In particular, the desirable thixotropic properties help reduce particle settling after application. In other words, the free radically polymerizable component provides a carrier in which the particle distribution remains very stable during storage and after being applied onto a substrate. This stability includes helping to maintain particles at the composition surface to a large extent after application to a substrate. By maintaining particle populations at the surface, high scratch resistance at the surface is maintained.

In some embodiments, at least one of the constituents of the reactive diluent optionally includes epoxy functionality in addition to free radically polymerizable functionality. In an illustrative embodiment, a diacrylate ingredient with a weight average molecular weight of about 500 to about 700 and including at least one backbone moiety derived from epoxy functionality is incorporated into the reactive diluent. One example of such a material is commercially available under the trade designation CN120 from Sartomer Co., Inc. A blend containing 80 parts by weight of this oligomer with 20 parts by weight of TMPTA is also available from this source under the trade designation CN120C80. In some embodiments, using from about 1 to about 25, alternatively about 8 to 20 parts by weight of this oligomer per about 1 to about 50 parts by weight, alternatively 5 to 20 parts by weight of the monofunctional constituents of the reactive diluent would be suitable. In an exemplary embodiment, using about 15 to 16 parts by weight of the CN120-80 admixture per about 12 parts by weight of monofunctional ingredients would be suitable. It is also contemplated that, in various non-limiting embodiments, all values and ranges of values, both whole and fractional, including and between those set forth above, are hereby expressly contemplated for use herein.

In addition to the reactive diluent, a free radically polymerizable component may include one or more free radically polymerizable resins. When the free radically polymerizable component includes one or more free radically polymerizable resins, the amount of such resins incorporated into the compositions may vary over a wide range. As general guidelines the weight ratio of the free radically polymerizable resin(s) to the reactive diluent often may be in the range from about 1:20 to about 20:1, alternatively about 1:20 to about 1:1, alternatively about 1:4 to about 1:1, and alternatively about 1:2 to about 1:1. It is also contemplated that, in various non-limiting embodiments, all values and ranges of values, both whole and fractional, including and between those set forth above, are hereby expressly contemplated for use herein.

In illustrative embodiments, the free radically polymerizable resin component desirably includes one or more resins such as (meth)acrylated urethanes (i.e., urethane(meth)acrylates), (meth)acrylated epoxies (i.e., epoxy (meth)acrylates), (meth)acrylated polyesters (i.e., polyester(meth)acrylates), (meth)acrylated(meth)acrylics, (meth)acrylated silicones, (meth)acrylated amines, (meth)acrylated amides; (meth)acrylated polysulfones; (meth)acrylated polyesters, (meth)acrylated polyethers (i.e., polyether (meth)acrylates), vinyl(meth)acrylates, and (meth)acrylated oils. In practice, referring to a resin by its class (e.g., polyurethane, polyester, silicone, etc.) means that the resin includes at least one moiety characteristic of that class even if the resin includes moieties from another class. Thus, a polyurethane resin includes at least one urethane linkage but also might include one or more other kinds of polymer linkages as well.

Representative examples of free radically polymerizable resin materials include radiation curable (meth)acrylates, urethanes and urethane (meth)acrylates (including aliphatic polyester urethane (meth)acrylates) such as the materials described in U.S. Pat. Nos. 5,453,451, 5,773,487 and 5,830,937, each of which is incorporated by reference in various non-limiting embodiments. Additional free radically polymerizable resins that would be suitable include those described in PCT Publication No. WO 02/077109, which is also incorporated herein by reference in various non-limiting embodiments. A wide range of such materials are commercially available.

Various embodiments of the resin component include at least a first free radically polymerizable polyurethane resin that can have a glass transition temperature (Tg) of at least about 50° C. and is at least trifunctional, alternatively at least tetrafunctional, alternatively at least pentafunctional, and alternatively at least hexafunctional with respect to free radically polymerizable functionality. This first resin desirably can have a Tg of at least about 60° C., alternatively at least about 80° C., and alternatively at least about 100° C. In one mode of practice, a free radically polymerizable urethane resin having a Tg of about 50° C. to about 60° C., and that is hexavalent with respect to (meth)acrylate functional would be suitable. An exemplary embodiment of such a hexafunctional resin is commercially available under the trade designation Genomer 4622 from Rahn. It is also contemplated that, in various non-limiting embodiments, all values and ranges of values, both whole and fractional, including and between those set forth above, are hereby expressly contemplated for use herein.

In some embodiments, the first resin is used in combination with one or more other kinds of resins. Optionally, at least one of such other resins is also free radically polymerizable. For example, some embodiments incorporate the first resin in combination with at least a second free radically polymerizable resin that can be mono or multifunctional with respect to free radically polymerizable moieties. If present, the second free radically polymerizable resin can have a Tg over a wide range, such as from about −30° C. to about 120° C. In some embodiments, the second resin can have a Tg of less than about 50° C., alternatively less than about 30° C., and alternatively than about 10° C. Many embodiments of the second resin are polyurethane materials. An exemplary embodiment of such a resin is commercially available under the trade designation Desmolux U500 (formerly Desmolux XP2614) from Bayer MaterialSciencc AG. It is also contemplated that, in various non-limiting embodiments, all values and ranges of values, both whole and fractional, including and between those set forth above, are hereby expressly contemplated for use herein.

Resins can be selected to achieve desired gloss objectives. For example, formulating a composition with a first free radically polymerizable resin having a relatively high Tg over about 50° C. in combination with an optional second free radically polymerizable resin having a relatively low Tg, such as below about 30° C., is helpful to provide coatings with mid-range gloss (e.g., about 50 to about 70) or high-range gloss (greater than about 70). Formulating with only one or more free radically polymerizable resins having a relatively higher Tg tends to be helpful to provide coatings with lower gloss (e.g., below about 50). It is also contemplated that, in various non-limiting embodiments, all values and ranges of values, both whole and fractional, including and between those set forth above, are hereby expressly contemplated for use herein.

The weight ratio of the first and second resins may vary over a wide range. To provide coatings with excellent abrasion resistance and toughness with respect to embodiments in which the Tg of the second resin is under about 50° C., it is desirable if the ratio of the second, lower Tg resin to the first, higher Tg resin is in the range from about 1:20 to about 20:1, alternatively less than about 1:1, such as in the range from about 1:20 to about 1:1, alternatively about 1:20 to about 4:5, or alternatively about 1:20 to about 1:3. In one illustrative embodiment, a weight ratio of about 9:1 would be suitable. It is also contemplated that, in various non-limiting embodiments, all values and ranges of values, both whole and fractional, including and between those set forth above, are hereby expressly contemplated for use herein.

An exemplary embodiment of a free radically polymerizable component including a reactive diluent with an atypically high content of trifunctional or higher functionality includes from about 1 to about 10, alternatively about 4 to about 8 parts by weight of a lactam such as N-vinyl-2-pyrrolidone, about 1 to about 10, alternatively about 2 to about 8 parts by weight of another monofunctional material having a molecular weight under about 500 such as octodecyl acrylate, about 5 to about 25, alternatively about 7 to about 30 parts by weight of a difunctional reactive diluent such as 1,6-hexane diacrylate; about 1 to about 8, alternatively about 2 to 5 parts by weight of a trifunctional reactive diluent having a molecular weight under about 500 such as trimethylol propane triacrylate TMPTA, about 1 to about 20 parts by weight of a trifunctional oligomer having a molecular weight in the range from about 500 to about 2000, about 1 to about 40 parts by weight of a difunctional oligomer having epoxy functionality and a molecular weight in the range from about 500 to about 2000, about 1 to about 15 parts by weight of the first resin, and about 1 to about 15 parts by weight of the second resin. It is also contemplated that, in various non-limiting embodiments, all values and ranges of values, both whole and fractional, including and between those set forth above, are hereby expressly contemplated for use herein.

In alternative embodiments, the coating includes a first coat which provides a colored illustration, such as a pattern, by the application of colored coatings with the aid of the non-contact deposition applicator. A second, transparent coat consisting of one or more covering layers (or top coats) is superposed on this first coat for the purpose of protecting said first, colored coat.

In an embodiment, compositions are employed, including, for example, pigments, oligomers, reactive diluents and other additives familiar to the person skilled in the art. Suitable pigments are, for example, Pigment Yellow 213, PY 151, PY 93, PY 83, Pigment Red 122, PR 168, PR 254, PR 179, Pigment Red 166, Pigment Red 48:2, Pigment Violet 19, Pigment Blue 15:1, Pigment Blue 15:3, Pigment Blue 15:4, Pigment Green 7, Pigment Green 36, Pigment Black 7 or Pigment White 6. Suitable oligomers are, for example, aliphatic and aromatic urethane acrylates, polyether acrylates and epoxyacrylates, which acrylates may optionally be monofunctional or polyfunctional, e.g. difunctional, trifunctional to hexafunctional, and decafunctional. Suitable reactive diluents are, for example, dipropylene glycol diacrylate, tripropylene glycol diacrylate, tetrahydrofurfuryl acrylate, isobornyl acrylate and isodecyl acrylate. Further additives may be added to the inks for adjustment of their properties, such as, for example, dispersant additives, antifoams, photoinitiators, and UV absorbers.

In an embodiment, covering layers are employed. Suitable covering layers are, for example, products based on single-component (1K) or two-component (2K) isocyanate crosslinking systems (polyurethanes) or based on 1K or 2K epoxy systems (epoxy resins). In various embodiments, 2K systems are employed. The covering layer employed according to the disclosure can be transparent or translucent.

In two-component isocyanate crosslinking systems, isocyanates such as, for example, oligomers based on hexamethylene diisocyanate (HDI), diphenylmethane diisocyanate (MDI), isophorone diisocyanate (IPDI), or toluidine diisocyanate (TDI), e.g. isocyanurates, biuret, allophanates, and adducts of the isocyanates mentioned with polyhydric alcohols and mixtures thereof are employed as the curing component. Polyols such as, for example, OH group-containing polyesters, polyethers, acrylates and polyurethane, and mixtures thereof, are employed as the binding component, which polyols may be solvent-based, solvent-free, or water-dilutable.

In two-component epoxy systems, epoxy resins such as, for example, glycidyl ethers of bisphenols such as bisphenol A or bisphenol F and epoxidized aliphatic parent substances, and mixtures thereof, are employed as the binding component. NH-functional substances such as, for example, amines, amides and adducts of epoxy resins and amines, and mixtures thereof, are employed as the curing component.

In the case of polyol-containing binders, customary commercial isocyanate curing agents and in the case of epoxy resin-containing binders, NH-functional curing agents can be employed as the curing component.

In various embodiments, the mixing ratios of the binder and curing components are selected such that the weights of the respective components, in each case based on the amount of substance of the reactive groups, are present in an OH:NCO or epoxy:NH ratio in the range of from about 1:0.7 to about 1:1.5, alternatively from about 1:0.8 to about 1:1.2 or alternatively about 1:1. It is also contemplated that, in various non-limiting embodiments, all values and ranges of values, both whole and fractional, including and between those set forth above, are hereby expressly contemplated for use herein.

A 3-layer coating can be employed in various industrial sectors. The basecoat is formed by primers that can be applied to wood, metal, glass, and plastics materials. Examples of suitable primers for use are products based on single-component (1K) or two-component (2K) isocyanate crosslinking systems (polyurethanes) or based on 1K or 2K epoxy systems (epoxy resins).

Depending upon the type of crosslinking agent, the composition of this disclosure can be formulated as one-pack (1K) or two-pack (2K) composition. One-pack compositions may be air-dry coatings or un-activated coatings. The term “air-dry coating” or “un-activated coating” refers to a coating that dries primarily by solvent evaporation and does not require crosslinking to form a coating film having desired properties. If polyisocyanates with free isocyanate groups are used as the crosslinking agent, the composition can be formulated as a two-pack composition in that the crosslinking agent is mixed with other components of the composition only shortly before coating application. If blocked polyisocyanates are, for example, used as the crosslinking agent, the compositions can be formulated as a one-pack (1K) composition.

“Two-pack composition” or “two component composition” means a thermoset composition including two components stored in separate containers. These containers are typically sealed to increase the shelf life of the components of the composition. The components are mixed prior to use to form a pot mix. The pot mix is applied as a layer of desired thickness on a substrate surface, such as an automobile body or body parts. After application, the layer is cured under ambient conditions or bake cured at elevated temperatures to form a coating on the substrate surface having desired coating properties, such as high gloss, smooth appearance, and durability. Providing the Non-Contact Deposition Applicator:

The method also includes the step of providing the non-contact deposition applicator including a nozzle. This applicator may be any known in the art. For example, the non-contact deposition applicator may be further defined as a non-contact dropwise deposition applicator. The non-contact deposition applicator may alternatively be defined as a high transfer efficiency applicator. The non-contact deposition applicator may be configured as continuous feed, drop-on-demand, or selectively both. The non-contact deposition applicator may apply the composition via valve jet, piezo-electric, thermal, acoustic, or ultrasonic membrane. In various embodiments, the non-contact deposition applicator is a piezoelectric applicator configured to apply the composition drop-on-demand. The non-contact deposition applicator can include a piezoelectric element configured to deform between a draw position, a rest position, and an application position. In various embodiments, the non-contact deposition applicator may have a jetting frequency of from about 100 to about 1,000,000 Hz, alternatively from about 10,000 Hz to about 100,000 Hz, or alternatively from about 30,000 Hz to about 60,000 Hz.

The non-contact deposition applicator typically includes at least one nozzle that defines at least one nozzle orifice. The nozzle may be of any type known in the art. Similarly, the nozzle orifice may be sized and shaped as chosen by one of skill in the art. It is to be appreciated that each non-contact deposition applicator may include more than one nozzle, such as for applying a composition including effect pigments which may require a larger nozzle orifice. The nozzle orifice may have a nozzle diameter of from about 0.000001 to about 0.001, alternatively from about 0.000005 to about 0.0005, or alternatively from about 0.00002 to about 0.00018, meters (m). The nozzle orifice may have a nozzle diameter of at least about 0.000001, alternatively at least about 0.000005, or alternatively at least about 0.00002, meters (m). The nozzle orifice may have a nozzle diameter of no greater than about 0.001, alternatively no greater than about 0.0005, or alternatively no greater than about 0.00018, meters (m).

In various embodiments, the non-contact deposition applicator includes a plurality of nozzles. The nozzles can be oriented perpendicular to the traverse direction by which the non-contact deposition applicator moves. As a result, the spacing of the droplets of the composition is similar to the spacing of the nozzles to one another. Alternatively, the nozzles may be oriented diagonal relative to the traverse direction by which the non-contact deposition applicator moves. As a result, the spacing of the droplets of the composition can be decreased relative to the spacing of the nozzles to one another.

A plurality of the nozzles can be arranged in a linear configuration relative to one another along a first axis and a plurality of second nozzles of a second non-contact deposition applicator can be arranged in a linear configuration relative to one another along a second axis. The first axis and the second axis are typically parallel to each other.

The plurality of the first nozzles and the plurality of second nozzles can be spaced relative to each other to form a rectangular array and wherein the plurality of the first nozzles and the plurality of second nozzles are configured to alternate expelling of the composition between adjacent first and second nozzles of the rectangular array to reduce sag of the composition.

In various embodiments, the non-contact deposition applicator includes sixty nozzles aligned along an axis. However, it is to be appreciated that a print head can include any number of nozzles. Each nozzle may be actuated independent of the other nozzles to apply the composition to the substrate. During printing, independent actuation of the nozzles can provide control for placement of each of the droplets of the composition on the substrate.

Alternatively, one set of nozzles along a first axis may be closely spaced to another set of nozzles relative to the spacing of each of the nozzles along a second axis of a single non-contact deposition applicator. This configuration of nozzles may be suitable for applying different compositions by each of the non-contact deposition applicators to the substrate.

The nozzles may have any configuration known in the art, such as linear, concave relative to the substrate, convex relative to the substrate, circular, and the like. Adjustment of the configuration of the nozzles may be necessary to facilitate cooperation of the non-contact deposition applicator to substrates having irregular configurations, such as vehicles including mirrors, trim panels, contours, spoilers, and the like.

The non-contact deposition applicator may be configured to blend individual droplets to form a desired color. The non-contact deposition applicator may include nozzles to apply cyan compositions, magenta compositions, yellow compositions, and black compositions. The properties of compositions may be modified to promote blending. Further, agitation sources, such as air movement or sonic generators may be utilized to promote blending of the compositions. The agitation sources may be coupled to the non-contact deposition applicator or separate therefrom.

The non-contact deposition applicator may be configured to expel the composition through the nozzle orifice at an impact velocity of from about 0.2 m/s to about 20 m/s. Alternatively, the non-contact deposition applicator may be configured to expel the composition through the nozzle orifice at an impact velocity of from about 0.4 m/s to about 10 m/s. The nozzle orifice may have a nozzle diameter of from about 0.00004 m to about 0.00025 m. The composition may be expelled from the non-contact deposition applicator as a droplet having a particle size of at least about 10 microns. It is also contemplated that, in various non-limiting embodiments, all values and ranges of values, both whole and fractional, including and between those set forth above, are hereby expressly contemplated for use herein.

In various embodiments, at least about 80% of the droplets of the composition expelled from the non-contact deposition applicator contact the substrate. In other embodiments, at least about 85%, alternatively at least about 90%, alternatively at least about 95%, alternatively at least about 97%, alternatively at least about 98%, alternatively at least about 99%, or alternatively at least about 99.9% of the droplets of the composition expelled from the non-contact deposition applicator contact the substrate. Without being bound by theory, it is believed that an increase in the number of droplets contacting the substrate relative to the number of droplets that do not contact the substrate thereby entering the environment, improves efficiency of application of the composition, reduces waste generation, and reduces maintenance of the system. It is also contemplated that, in various non-limiting embodiments, all values and ranges of values, both whole and fractional, including and between those set forth above, are hereby expressly contemplated for use herein.

In various embodiments, at least about 80% of the droplets of the composition expelled from the non-contact deposition applicator are monodispersed such that the droplets have a particle size distribution of less than %. In other embodiments, at least about 85%, alternatively at least about 90%, alternatively at least about 95%, alternatively at least about 97%, alternatively at least about 98%, alternatively at least about 99%, or alternatively at least about 99.9% of the droplets of the composition expelled from the non-contact deposition applicator are monodispersed such that the droplets have a particle size distribution of less than %, alternatively less than about 15%, alternatively less than about 10%, alternatively less than about 5%, alternatively less than about 3%, alternatively less than about 2%, alternatively less than about 1%, or alternatively less than about 0.1%. While conventional applicators rely on atomization to form “a mist” of atomized droplets of a composition having a dispersed particle size distribution, the monodispersed droplets formed by the non-contact deposition applicator can be directed to the substrate thereby resulting in an improved transfer efficiency relative to conventional applicators. It is also contemplated that, in various non-limiting embodiments, all values and ranges of values, both whole and fractional, including and between those set forth above, are hereby expressly contemplated for use herein.

In various embodiments, at least about 80% of the droplets of the composition expelled from the non-contact deposition applicator to the substrate remain as a single droplet after contact with the substrate. In other embodiments, at least about 85%, alternatively at least about 90%, alternatively at least about 95%, alternatively at least about 97%, alternatively at least about 98%, alternatively at least about 99%, or alternatively at least about 99.9% of the droplets of the composition expelled from the non-contact deposition applicator to the substrate remain as a single droplet after contact with the substrate. Without being bound by theory, it is believed that splashing of the composition resulting from impact with the substrate can be minimized or eliminated by applying the composition utilizing the non-contact deposition applicator. It is also contemplated that, in various non-limiting embodiments, all values and ranges of values, both whole and fractional, including and between those set forth above, are hereby expressly contemplated for use herein.

In various embodiments, at least about 80% of the droplets of the composition expelled from the non-contact deposition applicator to the substrate remain as a single droplet after expulsion from the nozzle orifice of the non-contact deposition applicator. In other embodiments, at least about 85%, alternatively at least about 90%, alternatively at least about 95%, alternatively at least about 97%, alternatively at least about 98%, alternatively at least about 99%, or alternatively at least about 99.9% of the droplets of the composition expelled from the non-contact deposition applicator to the substrate remain as a single droplet after expulsion from the nozzle orifice of the non-contact deposition applicator. Without being bound by theory, it is believed that the formation of satellite droplet can be reduced or eliminated by applying the composition utilizing the non-contact deposition applicator. In various embodiments, impact velocity and nozzle diameter have an impact on satellite droplet formation. Satellite droplet formation may be reduced by considering the impact velocity and the nozzle diameter. It is also contemplated that, in various non-limiting embodiments, all values and ranges of values, both whole and fractional, including and between those set forth above, are hereby expressly contemplated for use herein.

In other embodiments, the non-contact deposition applicator may be configured to apply the composition at an impact velocity (v) in an amount of from about 0.01 to about 100, alternatively from about 0.1 to about 50, or alternatively from about 1 to about 12, meters per second (m/s). The non-contact deposition applicator may be configured to apply the composition at an impact velocity (v) in an amount of at least about 0.01, alternatively at least about 0.1, or alternatively at least about 1, m/s. The non-contact deposition applicator may be configured to apply the composition at an impact velocity (v) in an amount of no greater than about 100, alternatively no greater than about 50, or alternatively no greater than about 12, m/s. It is also contemplated that, in various non-limiting embodiments, all values and ranges of values, both whole and fractional, including and between those set forth above, are hereby expressly contemplated for use herein.

In one embodiment, the non-contact deposition applicator includes a manifold component and one or more actuator components, wherein the actuator components provide an array of fluid chambers, each including an element, such as an actuator element, and a nozzle. In such embodiments, the element causes the ejection of fluid droplets in a deposition direction through the nozzle in response to a signal. Moreover, the manifold component typically includes a first manifold chamber and a second manifold chamber. In various embodiments, the first manifold chamber is fluidically connected to the second manifold chamber via each of the fluid chambers in the array.

In another embodiment, the array of manifold chambers (and/or fluid chambers) extends in an array direction from a first longitudinal end to a second opposite longitudinal end of the non-contact deposition applicator, wherein the array direction is approximately perpendicular to the deposition direction.

In a further embodiment, the element is further defined as an actuator or actuator element that is able to cause the ejection of the fluid droplets in response an electrical signal. In one embodiment, the element is a piezoelectric crystal. In another embodiment, the element is chosen from a thermal resistor, a piezoelectric crystal, acoustic, a solenoid valve, or a combination thereof.

The non-contact deposition applicator, prior to droplet ejection, can apply shear to the composition that is sufficient to reduce a viscosity of the composition to about 0.02 to about 0.2 Pa-s at a about 1000 sec⁻¹ shear rate that is determined using ASTM 7867-13 with cone-and-plate or parallel plates and determined at a time of less than about 0.1 seconds prior to application.

Without intending to be bound by theory, it is believed that pre-shearing reduces the viscosity of the (non-Newtonian) composition enough so that it can flow into and through the nozzle. Typically, this pre-shear is applied immediately prior to the composition entering the nozzle. In other words, this pre-shear is applied such that the viscosity is low enough when measured at about 0.1, about 0.05, about 0.01, or even less, seconds right before the composition enters the nozzle. The pre-shearing occurs immediately prior to the composition entering the nozzle to reduce/minimize relaxation time and to minimize a chance that the composition can relax and increase in viscosity. For example, in various embodiments wherein the composition is non-Newtonian, once the shear is reduced or eliminated, the viscosity of the composition increases quickly and can increase to such an extent that the composition can act like a viscoelastic solid. If the composition reaches that point, then it will not be able to be forced into the nozzle because such force, applied in a quick manner, would cause the viscosity to sharply and quickly increase. In such a scenario, the composition would act almost as a solid and would not be able to enter the nozzle or be jetted onto the substrate. The pre-shearing can be accomplished by any method in the art.

In various embodiments, this viscosity that results from the pre-shearing is from about 0.005 to about 0.2 from about 0.01 to about 0.1, or from about 0.01 to about 0.05, Pa-s at about 1000 sec-1. It is also contemplated that, in various non-limiting embodiments, all values and ranges of values, both whole and fractional, including and between those set forth above, are hereby expressly contemplated for use herein.

In additional embodiments, at least one reservoir can be disposed in fluid communication with at least one non-contact deposition applicator and configured to contain the composition. The non-contact deposition applicator can be configured to receive the composition from the at least one reservoir and configured to eject the composition through the at least one nozzle orifice. The reservoir is not particularly limited and may be any known in the art.

In various embodiments, the reservoir may be directly coupled to the non-contact deposition applicator or indirectly coupled to the non-contact deposition applicator via one or more tubes. More than one reservoir with each of the reservoirs containing different compositions (e.g., different colors, solid or effect pigments, basecoat or clearcoat, 2 pack-compositions) may be coupled to the non-contact deposition applicator for providing the different compositions to the same non-contact deposition applicator. The non-contact deposition applicator can be configured to receive the composition from the reservoir and configured to expel the composition through the nozzle orifice to the substrate.

### Applying the Coating Composition to the Patterned Surface:

The method also includes the step of applying the coating composition to the patterned surface through the nozzle to selectively wet the patterned surface and form a coating layer disposed in the pattern and having increased edge acuity and resolution, wherein the coating layer has a wet (applied) thickness of at least about 15 micrometers.

The step of applying may be any known in the art. For example, the step of applying may be further defined as using any one or more of the aforementioned applicators or components described above. In various examples, the step of applying is further defined as applying using an inkjet print head, applying using a continuous feed applicator, a drop-on-demand applicator, or combinations thereof, applying using one or more valve jets, piezo-electrics, and/or thermal, acoustic, or ultrasonic jets or membranes. The step of applying may be further defined as applying the composition via droplets having an average diameter of greater than about 50, about 75, about 100, about 125, about 150, about 175, about 200, or more micrometers. The droplets may be alternatively defined as filaments. For example, the applicator may apply the composition using a fluid stream that is about 20 to about 200, about 25 to about 175, about 50 to about 150, about 75 to about 125, or about 100, μm in diameter.

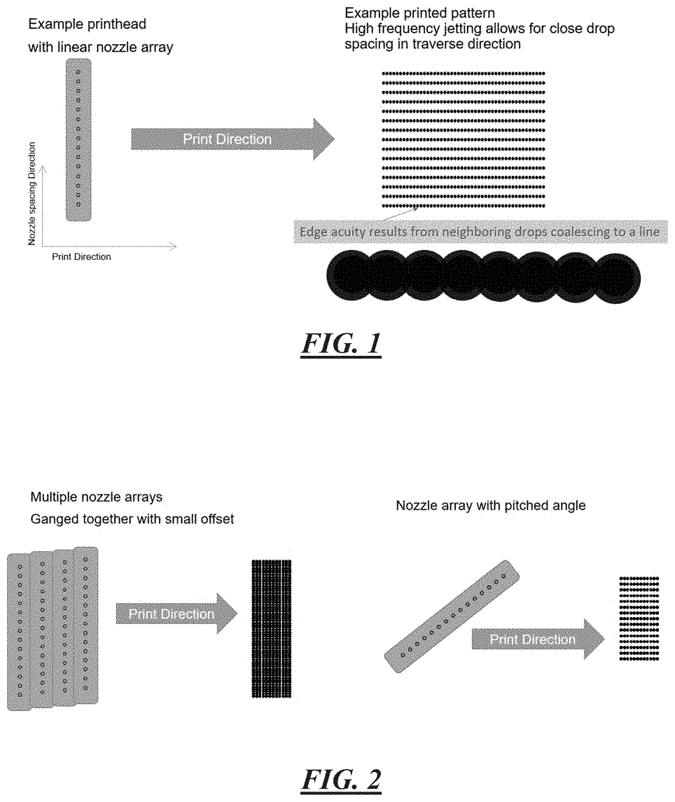

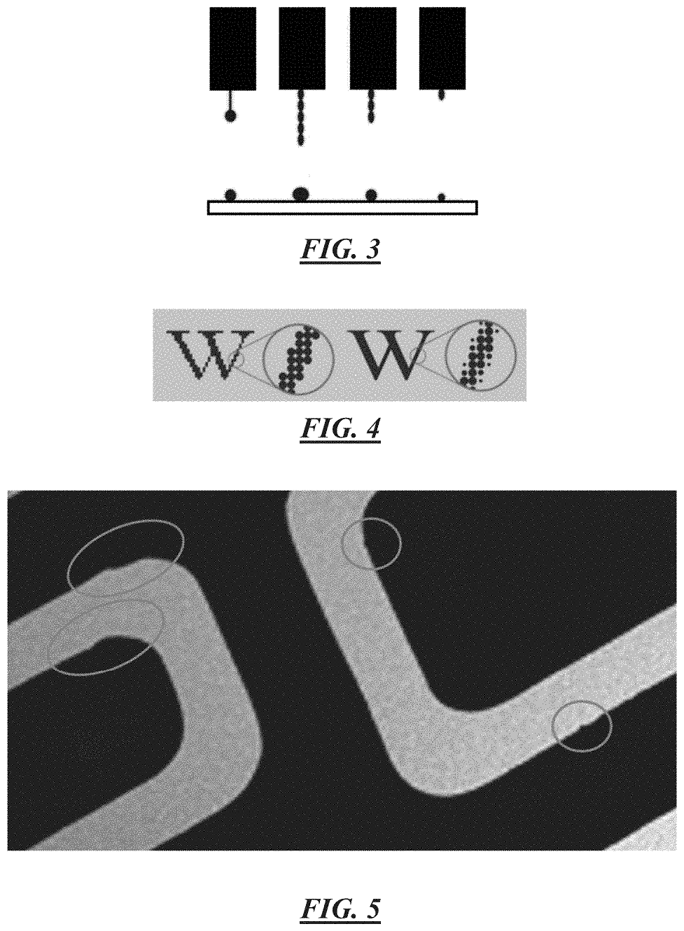

In one embodiment, the non-contact deposition applicator applies the composition in a print direction that is transverse to a direction of nozzle spacing such that the edge acuity and resolution is increased in both the print direction and the direction of nozzle spacing, e.g. as shown in FIG. 1. Alternatively, the step of applying may be further defined as applying through a ganged array of printheads and/or through a nozzle array at a pitched angle, e.g. as shown in FIG. 2.

Without intending to be bound by any particular theory, it is believed that the step of applying will allow the composition to selectively wet the areas that have the higher surface energy due to the pre-treatment or surface treatment to the exclusion (or substantial exclusion) of the areas that were not pre-treated/surface treated thereby “directing” the composition to the specific areas desired by the user. For example, substantial exclusion may describe that the selective wetting applies to greater than about 50, about 55, about 60, about 65, about 70, about 75, about 80, about 85, about 90, about 95, or even about 99, % of the desired surface area to the exclusion (or non-wetting) of the other non-desired area. In other words, the coating composition will only wet the desired areas thereby forming a very well defined pattern/design that has excellent edge acuity and resolution, e.g. a resolution of about 600 dpi or greater.

In theory, the use of the surface treatment will eliminate a need to use a physical mask on the surface thereby eliminating any issues typically associate with the quality of edge contact of the mask, of elastic release of the composition as the mask is removed, of any smudging or smearing of the composition as the mask is removed, etc. Accordingly, the instant method allows for non-contact application which means that there is no contact of the mask with the substrate. However, a mask can be used if desired. For example, the defects shown in FIG. 5 may be avoided in part or entirely.

It is theorized that when automotive paints are applied using traditional for-ink applicators, the large paint drops will not be able to achieve sufficient resolution to give edge acuity demanded by OEM automotive customers. However, if the substrate is pretreated to increase selective wetting of certain areas of the surface as compared to other areas, the paint will flow into the desired places thereby increasing edge acuity and resolution to sufficient levels, e.g. to the level of visual acuity at a viewing distance of from a few inches to many feet. Moreover, in some embodiments, the use of masking techniques can direct the surface treatment at a high resolution thereby allowing larger paint drops to wet the target surface and not wet the untreated areas, thereby increasing edge acuity and resolution. These techniques can enable OEMs to utilize available low resolution printheads with various coating compositions having higher viscosities and still achieve high resolution images or patterns with excellent edge acuity.

After the coating composition is applied, it forms a coating layer that has a wet (applied) thickness of at least about 15 micrometers. In various embodiments, the thickness is greater than about 15, about 20, about 25, about 30, about 35, about 40, about 45, about 50, about 75, about 100, or more, micrometers. In one embodiment, a waterborne basecoat with 25% solids may be targeted for about 12 microns (dry film thickness). In another embodiment, an about 50% solids solvent borne basecoat with only about 8 microns dry film thickness may be applied at about 16 microns wet. In still other embodiments, the thickness is chosen by one of skill in the art and is typical of any typical automotive coating, whether that be a basecoat, clearcoat, etc. Typically, the thickness of the coating layer describes a thickness of the wet layer, i.e., a thickness before drying and/or curing.

### Cured Coating

The composition of this disclosure may be cured by any mechanism known in the art. As first introduced above, the composition typically cures to form a coating layer, or layer, or coating, on the surface of the substrate.

The coating layer may have a solvent resistance of at least about 5 double MEK rubs, alternatively at least about 20 double MEK rubs, or alternatively at least about 20 double MEK rubs, on a nonporous substrate in accordance with ASTM D4752. The coating layer may have a film tensile modulus of at least about 100 MPa, alternatively at least about 100 MPa, or alternatively at least about 200 MPa, in accordance with ASTM 5026-15. The coating layer formed from the composition including a crosslinker may have a crosslink density of at least about 0.2 mmol/cm³, alternatively at least about 0.5 mmol/cm³, or alternatively at least about 1.0 mmol/cm³, in accordance with ASTM D5026-15. The coating layer may have a gloss value of at least about 75, alternatively at least about 88, or alternatively at least about 92, at an about 20 degree specular angle in accordance with ASTM 2813. The coating layer may have a gloss retention of at least about 50%, alternatively at least about 70%, or alternatively at least about 90%, of the initial gloss value after 2000 hours of weathering exposure in accordance with ASTM D7869. The coating layer may have a wet (applied) thickness of at least about 5 microns, alternatively at least about 15 microns, or alternatively at least about 50 microns, in accordance with ASTM D7091-13. It is also contemplated that, in various non-limiting embodiments, all values and ranges of values, both whole and fractional, including and between those set forth above, are hereby expressly contemplated for use herein.

In various embodiments, the coating layer has a chip resistance of at least 4B/7C according to SAE J400. Alternatively, the coating layer has a chip resistance of at least 5B/8C according to SAE J400. The substrate may define a target area and a non-target area adjacent the target area. The non-contact deposition applicator may be configured to expel the composition through the nozzle orifice to the target area to form a coating layer having a chip resistance of at least 4B/7C according to SAE J400. The non-target area is typically substantially free of the coating layer. The analysis under SAE J400 is performed on a multilayer coating system including a primer, basecoat and clearcoat. In total the composite layering system is tested for mechanical integrity by applying chip resistance damage by stones or other flying objects. Following the method of SAE J400 (alternatively ASTM D-3170) using 2 kg of stone with diameter 8-16 mm, where both stone and test panels have been conditioned to −20° F. (−29° C.+/−2°), stones are projected to the test panel with 90° orientation using pressurized air at 70 psi (480 kPa+/−20) in time period less than 30 sec. After pulling tape to remove loose paint chips, the damage is assessed using a visual scale. It is also contemplated that, in various non-limiting embodiments, all values and ranges of values, both whole and fractional, including and between those set forth above, are hereby expressly contemplated for use herein.

In various embodiments, the coating layer is a substantially uniform layer according to macroscopic analysis. The term “substantially” as utilized herein means that at least about 95%, at least about 96%, at least about 97%, at least about 98%, at least about 99% of a surface of the coating layer covers a surface of the substrate or a surface of an intervening layer between the substrate and the coating layer. The phrase “macroscopic analysis” as utilized herein means that the analysis of the coating layer is performed based on visualization without a microscope. It is also contemplated that, in various non-limiting embodiments, all values and ranges of values, both whole and fractional, including and between those set forth above, are hereby expressly contemplated for use herein.

### Edge Acuity and Resolution:

Use of the instant method of this disclosure increases edge acuity and resolution. For example, the edge acuity may be defined as the degree to which an edge of an image appears sharp and precise and not fuzzy. Edge acuity can also be defined relative to sharpness of an image or pattern e.g. wherein sharpness is defined as the acuity, or contrast, between the edges of an object in an image. In still other embodiments, it is theorized that the human eye has a visual acuity of about 1 arc minute, such that if the pattern of this disclosure has a resolution that exceeds 1 arc minute, it exceeds visual acuity. This is desirable. In still other embodiments, the pattern or image should not exhibit edge aliasing. Even further, it is theorized that edge acuity results from neighboring circular drops applied along a straight line coalescing to that line, e.g. in a scalloped pattern, as is shown in FIG. 1.

To be more specific, the term resolution can describe a capability of a printing system to reproduce image detail. In general, two factors dictate the detail that can be reproduced by a printer: quantitative factors, such as the npi of a printhead or dpi of a print system, also known as addressability, and qualitative factors, or resolution, which define the level of sharpness and contrast.

Addressability is a characteristic of a printhead or array of printheads, whereas resolution is a factor of the drop size and relates directly to the perceived quality as seen by the human eye. When considering the overall performance of a printhead its npi, minimum drop size, sub-drop size, number of available greyscale levels, uniformity of drop volume, drop placement accuracy and integration into a print system all play a significant role. Perceived print resolution is dependent on the viewing distance, contrast, and on the viewing conditions.

Inkjet printheads are often exemplified their nozzle density or nozzles per inch (npi). This is also called native addressability, and can be described as the rectangular grid of possible printable dots defined by the nozzle distance along the axis of the printhead, and by the linear speed and print frequency in the axis of the media motion. Effective addressability is the smallest, consistent, incremental distance by which a printer can shift from the center position of one printed point to the center of its neighbor. When encoder resolution is increased on the media axis, this also increases the effective resolution, which in turn will influence print detail. Addressability can also be increased by interleaving multiple printheads to double the effective npi, or by mounting printheads at an angle.

The spatial measure of resolution of dots per inch (dpi) is only relevant when measuring single or binary droplets. The use of variable dot greyscale technology in a process color image increases the apparent or effective resolution visible to the human eye, and renders the term dpi meaningless as a standalone measure. The number of grey levels can be defined as the number of different dot sizes it is possible for a printing process to reproduce, including white, where no dot is present.

The terms effective or apparent resolution are often used when referring to the perceived resolution of a printed image using greyscale technology. The capability of varying dot size line by line and pixel by pixel results in a higher perceived print resolution than the basic printhead dpi specification. The more levels of visible greyscale, the smoother the color transitions become, resulting in a level of print quality comparable with high dpi binary or restricted greyscale images. Effective resolution can be calculated as dpi×the square root of the number of grey levels.

However, whether the human eye can detect defects in the edges of a pattern or in various designs is typically dependent on viewing distance. Therefore, relative to the instant disclosure, the viewing distance may be contemplated to be about 1 inch, about 6 inches, about 1 foot, about 3 feet, about 5 feet, about 10 feet, or even greater. Accordingly, the edge of the instant pattern may be sharp and without visually noticeable defects at any one or more of these distances. In further embodiments, the edge acuity and/or resolution should exceed about 500, about 550, about 600, or even greater, dpi.

The ability of any system to achieve high effective resolution is one factor of perceived print quality. Ultimately it is the capability of the human eye which is the final determinant, and this is governed by the distance from the eye to the image—the viewing distance. The resolving power of the average 20/20 adult human eye, commonly referred to as normal visual acuity, is considered to be one arc minute (a unit of angular measurement equal to 1/60th of one degree). This translates to a dot size of about 29 microns at the eye's closest focusing distance of 10 cm (4″). This in turn equates to an effective resolution of about 876 dpi. Resolving power decreases with an increase in distance so that at the average reading distance of 30 cm (12″), the finest resolution that the eye (at one arc minute) can perceive under ideal viewing conditions is about 89 microns or about 300 dpi. Resolving power also diminishes based on other variables such as iris diameter, light levels, contrast, and light wavelengths. This means that the minimum effective resolution or dpi level required for a specific viewing distance will normally be at the high end for 20/20 vision.

Any one or more of these factors may be considered and/or manipulated in the instant method to achieve improved edge acuity and/or resolution.

### Additional Embodiments

This disclosure also provides a method of pretreating a substrate onto which a patterned coating composition is applied utilizing a non-contact dropwise deposition applicator such that increased edge acuity and resolution is achieved. The step of pre-treating can be further defined as surface treating the surface of the substrate prior to the step of applying the composition, as is described in detail above.

The method includes the steps of providing the substrate having a surface that includes a non-porous polymer, pretreating the surface to form a pattern that has increased surface energy as compared to the non-surface treated surface, providing the coating composition including a carrier and a binder, providing the non-contact dropwise deposition applicator including a nozzle, and applying the coating composition to the patterned surface through the nozzle to selectively wet the patterned surface and form the patterned coating having increased edge acuity and resolution, wherein the coating layer has a wet (applied) thickness of at least about 15 micrometers.

This disclosure further provides a method of applying an automotive coating composition to a surface of an automobile component in a pattern utilizing an inkjet print head to increase edge acuity and resolution of the automotive coating composition in the pattern. The method includes the steps of providing the automobile component having the surface that includes a non-porous polymer chosen from a first water-borne or solvent-borne basecoat composition, applying a mask to the surface of the substrate, wherein the mask is disposed in the pattern, applying a surface treatment to the surface over the mask to form a positive and/or negative patterned surface that has increased surface energy as compared to the non-treated surface wherein the surface treatment is chosen from flame treatment, corona treatment, plasma treatment, and combinations thereof, removing the mask subsequent to the step of applying the surface treatment; providing the automotive coating composition including a carrier and a binder wherein the automotive coating composition is a second water-borne or solvent-borne basecoat composition, providing the inkjet print head including a nozzle, and applying the automotive coating composition to the patterned surface through the nozzle to selectively wet the patterned surface to form a coating layer disposed in the pattern and having increased edge acuity and resolution, wherein the coating layer has a wet (applied) thickness of at least about 15 micrometers and wherein the inkjet print head applies the composition via droplets having an average diameter of greater than about 50 micrometers.

Any one or more of the components of the aforementioned method may be any as described above. For example, any of the automobile components, water-borne or solvent-borne basecoat compositions, etc. may be as described above.

In various embodiments, the first water-borne or solvent-borne basecoat composition is different from the second water-borne or solvent-borne basecoat composition. For example, both the first and the second compositions may each be independently chosen from black, white, solids, and/or metallics such that they are the same or different from each other.

### Examples

A series of flame treated substrates are formed according to this disclosure.

Substrate 1 is a 1K high solids acrylosilane with melamine.

Substrate 2 is a 2K medium solids acrylic with isocyanate.

Substrate 3 is a 2K acrylic with isocyanate modified with silica particles.

Substrate 4 is TPO is purchased from LyondellBasell as Hifax TRC 779X. Hifax TRC 779X 1 BLACK is a 20% talc filled PP copolymer, with high melt flow, good paintability, excellent impact/stiffness balance and processability.

The flame treatment is completed by manually applying an open flame from a propane torch over the surface of the substrate. The flame is applied from a distance of about 5 mm for a time of about 15 seconds. Surface energy measurements are completed within one hour after exposure to the flame according to the method set forth in W. A. Zisman, Relation of the Equilibrium Contact Angle to Liquid and Solid Constitution, Advances in Chemistry 43 (1964), P. 1-51.

Substrate 1 exhibits a 4.0 mN/m increase in surface energy.

Substrate 2 exhibits a 6.1 mN/m increase in surface energy.

Substrate 3 exhibits a 5.8 mN/m increase in surface energy.

Substrate 4 exhibits a 11.5 mN/m increase in surface energy.

This data demonstrates that the substrates utilized in automotive applications can be effectively surface treated to increase surface energy which will allow for selective wetting by the coating compositions which will provided increased edge acuity and resolution.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method of applying a coating composition to a surface of a substrate in a pattern utilizing a non-contact deposition applicator to increase edge acuity and resolution of the coating composition in the pattern, said method comprising the steps of:
A. providing the substrate having the surface that comprises a non-porous polymer;
B. applying a surface treatment to the surface in a pattern to form a patterned surface that has increased surface energy as compared to the non-surface treated surface;
C. providing the coating composition comprising a carrier and a binder;
D. providing the non-contact deposition applicator comprising a nozzle;
E. applying the coating composition to the patterned surface through the nozzle to selectively wet the patterned surface and form a coating layer disposed in the pattern and having increased edge acuity and resolution, wherein the coating layer has a wet thickness of at least about 15 micrometers as applied.

2. The method of claim 1 further comprising the step of applying a mask to the surface of the substrate prior to said step of applying the surface treatment, wherein the mask is disposed in the pattern, wherein said step of applying the surface treatment is further defined as applying the surface treatment over the mask such that the surface treatment forms a positive and/or negative patterned surface, and wherein said method further comprises the step of removing the mask subsequent to said step of applying the surface treatment.

3. The method of claim 1 wherein said step of applying the surface treatment in the pattern is completed without a mask.

4. The method of claim 1 wherein the surface treatment is chosen from flame treatment, corona treatment, plasma treatment, and combinations thereof.

5. The method of claim 1 wherein the surface treatment is flame treatment and increases the surface energy from about 4 to about 11 mN/m.

6. The method of claim 1 wherein the surface treatment is corona treatment.

7. The method of claim 1 wherein the surface treatment is plasma treatment.

8. The method of claim 1 wherein the non-porous polymer is a baked clear coat and the coating composition is a wet solvent-borne topcoat composition.

9. The method of claim 1 wherein the non-porous polymer is a dry water-borne basecoat composition and the coating composition is a wet second water-borne basecoat composition.

10. The method of claim 1 wherein the non-porous polymer is a wet water-borne basecoat composition and the coating composition is a wet second water-borne basecoat composition.

11. The method of claim 1 wherein the non-porous polymer is a wet solvent-borne basecoat composition and the coating composition is a wet second solvent-borne basecoat composition.

12. The method of claim 1 wherein the non-porous polymer is a wet solvent-borne basecoat composition and the coating composition is a wet second solvent-borne basecoat composition.

13. The method of claim 1 wherein the non-contact deposition applicator is an inkjet print head.

14. The method of claim 1 wherein the non-contact deposition applicator is continuous feed or drop-on-demand or combinations thereof.

15. The method of claim 1 wherein the non-contact deposition applicator applies the composition via valve jet, piezo-electric, thermal, acoustic, or ultrasonic membrane.

16. The method of claim 1 wherein the non-contact deposition applicator applies the composition via droplets having an average diameter of greater than about 50 micrometers.

17. The method of claim 1 wherein the substrate is an automobile component.

18. The method of claim 1 wherein the non-contact deposition applicator applies the composition in a print direction that is transverse to a direction of nozzle spacing such that the edge acuity and resolution is increased in both the print direction and the direction of nozzle spacing.

19. A method of pretreating a substrate onto which a patterned coating composition is applied utilizing a non-contact dropwise deposition applicator such that increased edge acuity and resolution is achieved, said method comprising the steps of:
A. providing the substrate having a surface that comprises a non-porous polymer;
B. pretreating the surface to form a pattern that has increased surface energy as compared to the non-surface treated surface;
C. providing the coating composition comprising a carrier and a binder;
D. providing the non-contact dropwise deposition applicator comprising a nozzle;
E. applying the coating composition to the patterned surface through the nozzle to selectively wet the patterned surface and form the patterned coating having increased edge acuity and resolution, wherein the coating layer has a wet thickness of at least about 15 micrometers as applied.

20. A method of applying an automotive coating composition to a surface of an automobile component in a pattern utilizing an inkjet print head to increase edge acuity and resolution of the automotive coating composition in the pattern, said method comprising the steps of:
A. providing the automobile component having the surface that comprises a non-porous polymer chosen from a first water-borne or solvent-borne basecoat composition;
B. applying a mask to the surface of the substrate, wherein the mask is disposed in the pattern;
C. applying a surface treatment to the surface over the mask to form a positive and/or negative patterned surface that has increased surface energy as compared to the non-treated surface wherein the surface treatment is chosen from flame treatment, corona treatment, plasma treatment, and combinations thereof;
D. removing the mask subsequent to said step of applying the surface treatment;
E. providing the automotive coating composition comprising a carrier and a binder wherein the automotive coating composition is a second water-borne or solvent-borne basecoat composition;
F. providing the inkjet print head comprising a nozzle;
G. applying the automotive coating composition to the patterned surface through the nozzle to selectively wet the patterned surface to form a coating layer disposed in the pattern and having increased edge acuity and resolution, wherein the coating layer has a wet thickness of at least about 15 micrometers as applied and wherein the inkjet print head applies the composition via droplets having an average diameter of greater than about 50 micrometers.
